(19) United States
(12) Patent Application Publication
(10) Pub. No.: US 2013/0104931 A1
(43) Pub. Date: May 2, 2013

(54) Liquid Chemical for Forming Protective Film, and Cleaning Method for Wafer Surface

(71) Applicants: Shinobu Arata, Matsusaka-shi (JP); Masanori Saito, Matsusaka-shi (JP); Takashi Saio, Suzuka-shi (JP); Soichi Kumon, Matsusaka-shi (JP); Hidehisa Nanai, Toshima-ku (JP)

(72) Inventors: Shinobu Arata, Matsusaka-shi (JP); Masanori Saito, Matsusaka-shi (JP); Takashi Saio, Suzuka-shi (JP); Soichi Kumon, Matsusaka-shi (JP); Hidehisa Nanai, Toshima-ku (JP)

(73) Assignee: Central Glass Company, Limited, Ube-shi (JP)

(21) Appl. No.: 13/807,708

(22) PCT Filed: Jun. 15, 2011
(86) PCT No.: PCT/JP2011/063635

§ 371 Date: Dec. 28, 2012

(30) Foreign Application Priority Data
Jun. 30, 2010 (JP) 2010-150536
Jun. 7, 2011 (JP) 2011-127149

(51) Int. Cl. C09D 5/38

(52) U.S. Cl. CPC C09D 5/38
USPC 134/4; 106/287.17; 106/287.19; 106/287.18

(57) ABSTRACT

Disclosed is a liquid chemical for forming a water repellent protective film at least on surfaces of recessed portions of a metal-based wafer, the liquid chemical for forming a water repellent protective film being characterized by comprising a surfactant which has an HLB value of 0.001-10 according to Griffin's method and includes a hydrophobic moiety having a C₆-C₁₈ hydrocarbon group and water, and characterized in that the concentration of the surfactant in the liquid chemical is not smaller than 0.00001 mass % and not larger than the saturated concentration relative to 100 mass % of the total amount of the liquid chemical. This liquid chemical can improve a cleaning step which tends to induce a metal-based wafer to cause a pattern collapse.

### TECHNICAL FIELD

The present invention relates to a technique of cleaning a substrate (a wafer) in semiconductor device fabrication and the like.

### BACKGROUND OF THE INVENTION

Semiconductor devices for use in networks or digital household electric appliances are being further desired to be sophisticated, multifunctional, and low in power consumption. Accordingly, the trend toward micro-patterning for circuits has been developed. As the development of micro-patterning proceeds, a pattern collapse of the circuits has been becoming controversial. In semiconductor device fabrication, cleaning steps for the purpose of removing particles and metallic impurities are frequently employed, which results in a 30-40% occupation of the whole of a semiconductor fabrication process by the cleaning step. If the aspect ratio of the pattern is increased with the trend toward micro-patterning of the semiconductor devices, the pattern is to collapse when a gas-liquid interface passes through the pattern after cleaning or rinsing. This phenomenon is referred to as a pattern collapse.

In Patent Publication 1, there is disclosed a cleaning method where a wafer having an uneven pattern by a film containing silicon is surface-reformed by oxidation and the like and a water repellent protective film is formed on the surface by using a water-soluble surfactant or a silane coupling agent thereby reducing the capillary force and preventing a pattern collapse.

### REFERENCES ABOUT PRIOR ART

### Patent Publication

Patent Publication 1; Japanese Patent No. 4403202

### SUMMARY OF THE INVENTION

The present invention relates to a technique for cleaning a substrate (a wafer) in semiconductor device fabrication and the like, the objective of which is to enhance the production yield of devices having such a circuit pattern as to be particularly fine and high in aspect ratio. The present invention particularly relates to a liquid chemical for forming a water repellent protective film which liquid chemical aims to improve a cleaning step which tends to induce a wafer having an uneven pattern at its surface to cause an uneven pattern collapse, and the like. Hitherto, there has generally been used a wafer containing silicon element at its surface as the above-mentioned wafer; however, a wafer (hereinafter, sometimes referred to as “a metal-based wafer” or merely as “a wafer”) that contains a material (hereinafter, sometimes referred to as “a metal-based material”) including at least one kind of element selected from the group consisting of titanium, tungsten, aluminum, copper, tin, tantalum and ruthenium has become used together with the diversification of the pattern. However, in a case of a wafer on which surface a sufficient amount of reactive functional groups e.g. silanol groups does not exist (like the above-mentioned metal-based wafer), it is not possible to form a water repellent protective film for preventing the pattern collapse even if the water-soluble surfactant or the silane coupling agent as discussed in Patent Publication 1 is employed, which is a problem in that the pattern collapse cannot be prevented. An object of the present invention is to provide a liquid chemical for forming a protective film, the liquid chemical being able to form a water repellent protective film for improving a cleaning step which tends to induce the pattern collapse, by forming a water repellent protective film at least on surfaces of recessed portions of the metal-based wafer so as to reduce an interaction between a liquid retained in the recessed portions and the surfaces of the recessed portions.

The pattern collapse is to occur when an gas-liquid interface passes through the pattern at the time of drying a wafer. It is said that the reason thereof is that a difference in height of residual liquid between a part having high aspect ratio and a part having low aspect ratio causes a difference in capillary force which acts on the pattern.

Accordingly, by decreasing the capillary force, it is expected that the difference in capillary force due to the difference in height of residual liquid is so reduced as to resolve the pattern collapse. The magnitude of the capillary force is the absolute value “P” obtained by the equation as shown below. It is expected from this equation that the capillary force can be reduced by decreasing γ or cos θ.

P=2×γ×cos θ/S

(In the equation, γ represents the surface tension of a liquid retained in the recessed portions, θ represents the contact angle of the liquid retained in the recessed portions to the surfaces of the recessed portions, and S represents the width of the recessed portions.)

A liquid chemical for forming a water repellent protective film (hereinafter, sometimes referred to as “a liquid chemical for forming a protective film” or merely as “a liquid chemical”), according to the present invention is a liquid chemical for forming a water repellent protective film (hereinafter, sometimes referred to merely as “a protective film”) on a wafer that has an uneven pattern at its surface and contains at least one kind of element selected from the group consisting of titanium, tungsten, aluminum, copper, tin, tantalum and ruthenium (hereinafter, sometimes referred to as “a metal-based material”) at surfaces of recessed portions of the uneven pattern, the water repellent protective film being formed at least on the surfaces of the recessed portions. The liquid chemical is characterized by comprising a surfactant which has an HLB value of 0.001-10 according to Griffin's method and includes a hydrophobic moiety having a C₆-C₁₈ hydrocarbon group and water, and characterized in that the concentration of the surfactant in the liquid chemical is not smaller than 0.00001 mass % and not larger than the saturated concentration relative to 100 mass % of the total amount of the liquid chemical.

The above-mentioned surfactant is a substance containing both a hydrophobic moiety and a functional moiety that has an affinity with the metal-based materials, in a molecule. The functional moiety is regarded as a hydrophilic moiety in a case of having a property where a water molecule can be added to the functional moiety (a hydration property). In this case, the addition of water to the functional moiety may be an addition established by Van der Waals attraction, the electrostatic interaction or formation of a hydrogen bond or may be an addition established by a coordinate bond with a water molecule.

The surfactant has an HLB value (Hydrophile Lipophile Balance) of from 0.001 to 10, according to Griffin's method. The HLB value according to Griffin's method is obtained from the following equation.

HLB value=20×(the total of formula weight of the hydrophilic moiety)/(molecular weight)

An HLB value of less than 0.001 requires a long hours to form the protective film and tends to form the protective film insufficiently. An HLB value of more than 10 tends to make a water repellency-imparting effect on the surface of the metal-based wafer insufficient. A more preferable HLB value is 0.005 to 7.

The liquid chemical contains the surfactant and water, wherein the concentration of the surfactant in the liquid chemical is not larger than the saturated concentration. The saturated concentration is the maximal concentration to which the surfactant can completely be dissolved in a solvent. In a case of exceeding the saturated concentration, the surfactant in a mixture liquid forms a micelle to cause emulsification or phase separation of the liquid chemical, thereby providing an inhomogeneous liquid chemical. A micelle or a liquid formed by phase separation, i.e., a liquid in an inhomogeneous condition can become the cause of particles. A concentration not larger than the saturated concentration is in a condition where the surfactant is completely dissolved in water, so that the liquid chemical is homogeneous and cannot be the cause of particles.

The surfactant includes a hydrophobic moiety having a C₆-C₁₈ hydrocarbon group. A carbon number of less than 6 tends to make a water repellency-imparting effect on the surface of the metal-based wafer insufficient. Meanwhile, a carbon number of 18 or more makes the freezing point higher than room temperature to cause deposition, thereby possibly becoming particles. The more preferable carbon number is 8 to 18. Incidentally, hydrocarbon group discussed in the present invention may be one consisting of carbon element and hydrogen element or may be one including halogen element such as fluorine, chlorine, bromine, iodine and the like as other elements, particularly preferably one including fluorine element.

Additionally, it is preferable that the surfactant includes a functional moiety that has an affinity with metal-based materials. In this specification, “an affinity” means that the surfactant is adsorbed on a surface of a metal-based material by Van der Waals attraction, an electrostatic interaction and the like that act between the metal-based material and the functional moiety of the surfactant.

Moreover, it is preferable that the surfactant includes, in its structure, one or more functional moieties having an affinity with the metal-based materials. By having one or more functional moieties in its structure, hydrophobic moieties of the surfactant become more readily disposed toward the direction apart from the substrate so as to enhance the water repellency-imparting effect, which preferably results in an improvement of the effect of preventing the collapse of the uneven pattern. It is more preferable that the surfactant includes, in its structure, one functional moiety having an affinity with the metal-based materials; with this, hydrophobic moieties of the surfactant become much more readily disposed toward the direction apart from the substrate so as to further enhance the water repellency-imparting effect, which preferably results in a further improvement of the effect of preventing the collapse of the uneven pattern.

Additionally, it is preferable that the surfactant includes a hydrophobic moiety having a C₆-C₁₈ straight-chain hydrocarbon group. The C₆-C₁₈ straight-chain hydrocarbon group may be substituted with a halogen element(s) at a part of its hydrogen elements or may be one having a C₆-C₁₈ straight-chain hydrocarbon group at a part of branched carbon chains. Since the C₆-C₁₈ hydrocarbon group included in the hydrophobic moiety is straight-chain one, hydrophobic moieties of the surfactant become much more readily disposed toward the direction apart from the substrate so as to further enhance the water repellency-imparting effect. This is preferable because the effect of preventing the collapse of the uneven pattern is further improved as a result.

Furthermore, it is preferable that the surfactant includes a hydrophobic moiety having a C₆-C₁₈ straight-chain hydrocarbon group that consists of carbon element and hydrogen element. Since the C₆-C₁₈ straight-chain hydrocarbon group included in the hydrophobic moiety consists of carbon element and hydrogen element, hydrophobic moieties of the surfactant become much more readily disposed toward the direction apart from the substrate so as to further enhance the water repellency-imparting effect. This is preferable because the effect of preventing the collapse of the uneven pattern is further improved as a result.

Moreover, the liquid chemical may contain a solvent. When the concentration of water is not lower than 50 mass % relative to the total amount of the contained solvent, the inflammability of the liquid chemical is decreased and this is preferable. It is more preferable that the concentration of water is not lower than 70 mass %, much more preferably not lower than 85 mass %.

Furthermore, it is preferable that the liquid chemical is formed of the surfactant and water because the liquid chemical becomes provided not to contain an organic solvent or the like and therefore becomes provided to be one lower in environmental burden.

The above-mentioned metal-based wafer is one that contains, at the surfaces of the recessed portions of the uneven pattern: at least one kind of element selected from the group consisting of titanium, tungsten, aluminum, copper, tin, tantalum and ruthenium; preferably at least one kind of element selected from the group consisting of titanium, tungsten and ruthenium; and particularly preferably ruthenium. In a case of a wafer containing silicon element at the surfaces of the recessed portions of the uneven pattern, there are a multitude of silanol groups (SiOH groups) on the surfaces. These silanol groups serve as reaction points to be reacted with a silane coupling agent, so that the water repellent protective film can easily be formed on the surfaces of the recessed portions. On the other hand, in a case of the metal-based wafer, its surface has fewer reaction points such as the silanol groups and therefore it is difficult to form the protective film with a compound such as the silane coupling agent. Additionally, in the present invention, “a wafer having an uneven pattern at its surface” means a wafer which is in a condition where the uneven pattern has already been formed on the surface by etching, imprint or the like. Moreover, it is also possible to adopt a wafer on which another process such as metal routing has been performed, as far as the wafer has an uneven pattern at its surface.

The liquid chemical for forming a protective film according to the present invention is used in such a manner as to substitute a cleaning liquid with the liquid chemical in a step of cleaning the metal-based wafer. Additionally, the thus substituted liquid chemical may be substituted with another cleaning liquid.

While the cleaning liquid is substituted with the liquid chemical for forming a protective film and the liquid chemical is retained at least on the surfaces of the recessed portions of the uneven pattern as discussed above, a protective film is formed at least on the surfaces of the recessed portions of the uneven pattern. It is not necessary for the protective film of the present invention to be formed continuously and evenly; however, it is preferable to form it continuously and evenly in order to provide a more excellent water repellency.

In the present invention, “a water repellent protective film” means a film formed on a wafer surface so as to reduce the wettability of the wafer surface or to impart water repellency to the same. In the present invention, “water repellency” means a reduction of a surface energy of an article surface thereby weakening the interaction between water or another liquid and the article surface (i.e., at the interface), such as hydrogen bond, intermolecular forces and the like. The effect of reducing the interaction is particularly outstanding against water, but this effect is exhibited also against a mixture liquid of water and a liquid other than water or against a liquid other than water. With the reduction of the interaction, it becomes possible to increase the contact angle of the liquid to the article surface.

A method for cleaning a wafer surface, according to the present invention is a method using the liquid chemical for forming a water repellent protective film of the present invention, the method being for cleaning a surface of a wafer that has an uneven pattern at its surface and contains at least one kind of element selected from the group consisting of titanium, tungsten, aluminum, copper, tin, tantalum and ruthenium at surfaces of recessed portions of the uneven pattern, the protective film being formed at least on the surfaces of the recessed portions of the uneven pattern, the method being characterized by comprising:

a step of cleaning a surface of a wafer by using a cleaning liquid;

a step of forming a water repellent protective film at least on surfaces of recessed portions of the uneven pattern by using the liquid chemical for forming a water repellent protective film;

a step of removing a liquid formed of the cleaning liquid and/or the liquid chemical from the surfaces of the uneven pattern; and

a step of removing the water repellent protective film after the step of removing the liquid.

In the method for cleaning a wafer surface according to the present invention, it is preferable to use a water-based cleaning liquid as the cleaning liquid. The liquid chemical for forming a protective film of the present invention is substitutable with the water-based cleaning liquid, so that it is possible to improve tact time by using the water-based cleaning liquid.

In the present invention, the protective film is formed at least on the surfaces of the recessed portions of the uneven pattern when the liquid is removed from the recessed portions (in other words, when the liquid is dried); therefore, the capillary force which acts on the recessed portions is so reduced that the pattern collapse becomes difficult to occur. Additionally, the protective film is to be removed after a drying step.

### EFFECTS OF THE INVENTION

The protective film formed by using the liquid chemical for forming a protective film of the present invention is excellent in water repellency. Therefore, in a wafer that has an uneven pattern at its surface and contains at least one kind of element selected from the group consisting of titanium, tungsten, aluminum, copper, tin, tantalum and ruthenium at surfaces of recessed portions of the uneven pattern, it is possible to reduce an interaction between a liquid retained in the recessed portions and the surfaces of the recessed portions, and by extension it is possible to bring about a pattern collapse-preventing effect. With the use of the liquid chemical, a cleaning step conducted in a process for producing a wafer that has an uneven pattern at its surface is improved without lowering throughput. Accordingly, a process for producing a wafer that has an uneven pattern at its surface, which is conducted by using the liquid chemical for forming a protective film of the present invention, is excellent in productivity.

The liquid chemical for forming a protective film, according to the present invention is adaptable to uneven patterns having aspect ratios expected to rise more and more, for example, to an aspect ratio of not less than 7, and therefore allows cost reduction in producing more sophisticated semiconductor devices. In addition to this, the liquid chemical is adaptable without considerably modifying conventional apparatuses, which results in being one that can be applied to production of various kinds of semiconductor devices.

### BRIEF EXPLANATION OF THE DRAWINGS

FIG. 1 A schematic plan view of a wafer 1 whose surface is made into a surface having an uneven pattern 2.

FIG. 2 A view showing a part of a-a′ cross section of FIG. 1.

FIG. 3 A schematic view showing a condition where a liquid chemical 8 for forming a protective film is retained in recessed portions 4.

FIG. 4 A schematic view showing a condition where a liquid 9 is retained in the recessed portions 4 on which a protective film is formed.

### DETAILED DESCRIPTION

A preferable method for cleaning a wafer, according to the present invention comprises:

(Step 1) a step of making a surface of a wafer into a surface having an uneven pattern;

(Step 2) a step of supplying a water-based cleaning liquid to surfaces of the uneven pattern of the wafer thereby retaining the water-based cleaning liquid at least on surfaces of recessed portions of the uneven pattern;

(Step 3) a step of substituting the water-based cleaning liquid with a cleaning liquid (A) different from the above-mentioned water-based cleaning liquid (hereinafter, the cleaning liquid (A) is sometimes referred to merely as “a cleaning liquid (A)”) thereby retaining the cleaning liquid (A) at least on the surfaces of the recessed portions of the uneven pattern;

(Step 4) a step of substituting the cleaning liquid (A) with a liquid chemical for forming a protective film thereby retaining the liquid chemical at least on the surfaces of the recessed portions of the uneven pattern;

(Step 5) a step of removing a liquid formed of the cleaning liquid and/or the liquid chemical from the surfaces of the uneven pattern by drying; and

(Step 6) a step of removing a water repellent protective film.

By performing the step 2 and/or the step 3, the wafer surface is cleaned. Incidentally, the step 2 or the step 3 may sometimes be omitted. The liquid chemical for forming a protective film, according to the present invention is substitutable with the water-based cleaning liquid, and therefore, the step 3 in particular can be omitted with no concern.

After the step 4, a substitution of the liquid chemical retained on the surfaces of the recessed portions of the uneven pattern with a cleaning liquid different from the liquid chemical (hereinafter, this cleaning liquid is sometimes referred to as “a cleaning liquid (B)”) may be conducted (hereinafter, this substitution is sometimes referred to as “a subsequent cleaning step”), and the step 5 may be performed thereafter. Additionally, after the subsequent cleaning step, the cleaning liquid (B) may be substituted with a water-based cleaning liquid and then the step 5 may be performed; however, in order to more greatly maintain the water repellency-imparting effect of the protective film, it is preferable to shift to the step 5 after the subsequent cleaning step. For the same reason, it is more preferable to directly shift to the step 5 after the step 4.

In the present invention, it is essential only that the liquid chemical or the cleaning liquid is retained at least on the surfaces of the recessed portions of the uneven pattern of the wafer; therefore, a cleaning style for a wafer is not particularly limited. Examples of the cleaning style for a wafer are: a sheet cleaning style represented by spin cleaning where a wafer is cleaned one by one in such a manner as to dispose the wafer generally horizontally and rotate it while supplying a liquid to the vicinity of the center of the rotation; and a batch style where a plurality of the wafer are cleaned in a cleaning bath by being immersed therein. Incidentally, the form of the liquid chemical or the cleaning liquid at the time of supplying the liquid chemical or the cleaning liquid at least to the recessed portions of the uneven pattern of the wafer is not particularly limited as far as it becomes the form of liquid at time of being retained in the recessed portions, and may be liquid, vapor or the like, for instance.

The surfactant preferably includes a functional moiety having an affinity with metal-based materials. Examples of the functional moiety having an affinity with metal-based materials are functional moieties including one or more element with unshared electron pair, such as amino group, isocyanate group, —(C═O)—W bond, —(C═O)—X—Y bond, —(C═O)—Z—(C═O)— bond, —SH bond, —OH bond and the like, in which W represents fluoro group, chloro group, bromo group and iodo group. X and Z represent oxygen element or sulfur element. Y represents hydrogen element, alkyl group, aromatic group, pyridyl group, quinolyl group, succinimide group, maleimide group, benzoxazole group, benzothiazole group and benzotriazole group, in which hydrogen element in these groups may be substituted with an organic group.

The surfactant has an HLB value of 0.001-10 according to Griffin's method and includes a hydrophobic moiety having a C₆-C₁₈ hydrocarbon group. As examples of such a surfactant, it is possible cite: compounds such as C₆H₁₃NH₂, C₇H₁₅NH₂, C₈H₁₇NH₂, C₉H₁₉NH₂, C₁₀H₂₁NH₂, C₁₁H₂₃NH₂, C₁₂H₂₅NH₂, C₁₃H₂₇NH₂, C₁₄H₂₉NH₂, C₁₅H₃₁NH₂, C₁₆H₃₃NH₂, C₁₇H₃₅NH₂, C₁₈H₃₇NH₂, C₆F₁₃NH₂, C₇F₁₅NH₂, C₈F₁₇NH₂, C₆Cl₁₃NH₂, C₇Cl₁₅NH₂, C₈Cl₁₇NH₂, C₆Br₁₃NH₂, C₇Br₁₅NH₂, C₈Br₁₇NH₂, C₆I₁₃NH₂, C₇I₁₅NH₂, C₈I₁₇NH₂, C₆F₁₁H₂NH₂, C₈F₁₅H₂NH₂, C₆Cl₁₁H₂NH₂, C₈Cl₁₅H₂NH₂, C₆Br₁₁H₂NH₂, C₈Br₁₅H₂NH₂, C₆I₁₁H₂NH₂, C₈I₁₅H₂NH₂, (C₆H₁₃)₂NH, (C₇H₁₅)₂NH, (C₈H₁₇)₂NH, (C₉H₁₉)₂NH, (C₁₀H₂₁)₂NH, (C₁₁H₂₃)₂NH, (C₁₂H₂₅)₂NH, (C₁₃H₂₇)₂NH, (C₁₄H₂₉)₂NH, (C₁₅H₃₁)₂NH, (C₁₆H₃₃)₂NH, (C₁₇H₃₅)₂NH, (C₁₈H₃₇)₂NH, (C₆F₁₃)₂NH, (C₇F₁₅)₂NH, (C₈F₁₇)₂NH, (C₆Cl₁₃)₂NH, (C₇Cl₁₅)₂NH, (C₈Cl₁₇)₂NH, (C₆Br₁₃)₂NH, (C₇Br₁₅)₂NH, (C₈Br₁₇)₂NH, (C₆I₁₃)₂NH, (C₇I₁₅)₂NH, (C₈I₁₇)₂NH, (C₆F₁₁H₂)₂NH, (C₈F₁₅H₂)₂NH, (C₆Cl₁₁H₂)₂NH, (C₈Cl₁₅H₂)₂NH, (C₆Br₁₁H₂)₂NH, (C₈Br₁₅H₂)₂NH, (C₆I₁₁H₂)₂NH, (C₈I₁₅H₂)₂NH, (C₆H₁₃)₃N, (C₇H₁₅)₃N, (C₈H₁₇)₃N, (C₉H₁₉)₃N, (C₁₀H₂₁)₃N, (C₁₁H₂₃)₃N, (C₁₂H₂₅)₃N, (C₁₃H₂₇)₃N, (C₁₄H₂₉)₃N, (C₁₅H₃₁)₃N, (C₁₆H₃₃)₃N, (C₁₇H₃₅)₃N, (C₁₈H₃₇)₃N, (C₆F₁₃)₃N, (C₇F₁₅)₃N, (C₈F₁₇)₃N, (C₆Cl₁₃)₃N, (C₇Cl₁₅)₃N, (C₈Cl₁₇)₃N, (C₆Br₁₃)₃N, (C₇Br₁₅)₃N, (C₈Br₁₇)₃N, (C₆I₁₃)₃N, (C₇I₁₅)₃N, (C₈I₁₇)₃N, (C₆F₁₁H₂)₃N, (C₈F₁₅H₂)₃N, (C₆Cl₁₁H₂)₃N, (C₈Cl₁₅H₂)₃N, (C₆Br₁₁H₂)₃N, (C₈Br₁₅H₂)₃N, (C₆I₁₁H₂)₃N, (C₈I₁₅H₂)₃N, (C₆H₁₃)(CH₃)NH, (C₇H₁₅)(CH₃)NH, (C₈H₁₇)(CH₃)NH, (C₉H₁₉)(CH₃)NH, (C₁₀H₂₁)(CH₃)NH, (C₁₁H₂₃)(CH₃)NH, (C₁₂H₂₅)(CH₃)NH, (C₁₃H₂₇)(CH₃)NH, (C₁₄H₂₉)(CH₃)NH, (C₁₅H₃₁)(CH₃)NH, (C₁₆H₃₃)(CH₃)NH, (C₁₇H₃₅)(CH₃)NH, (C₁₈H₃₇)(CH₃)NH, (C₆F₁₃)(CH₃)NH, (C₇F₁₅)(CH₃)NH, (C₈F₁₇)(CH₃)NH, (C₆H₁₃)(CH₃)₂N, (C₇H₁₅)(CH₃)₂N, (C₈H₁₇)(CH₃)₂N, (C₉H₁₉)(CH₃)₂N, (C₁₀H₂₁)(CH₃)₂N, (C₁₁H₂₃)(CH₃)₂N, (C₁₂H₂₅)(CH₃)₂N, (C₁₃H₂₇)(CH₃)₂N, (C₁₄H₂₉)(CH₃)₂N, (C₁₅H₃₁)(CH₃)₂N, (C₁₆H₃₃)(CH₃)₂N, (C₁₇H₃₅)(CH₃)₂N, (C₁₈H₃₇)(CH₃)₂N, (C₆F₁₃)(CH₃)₂N, (C₇F₁₅)(CH₃)₂N, (C₈F₁₇)(CH₃)₂N and the like; inorganic acid salts of these, such as carbonates, hydrochlorides, sulfates, nitrates and the like; and organic acid salts of these, such as acetates, propionates, butyrates, phthalates and the like. Incidentally, in a case of forming a salt, the surfactant preferably has an HLB value of from 0.001 to 10 before forming the salt.

It is also possible to cite, for example, compounds such as C₆H₁₃NCO, C₇H₁₅NCO, C₈H₁₇NCO, C₉H₁₉NCO, C₁₀H₂₁NCO, C₁₁H₂₃NCO, C₁₂H₂₅NCO, C₁₃H₂₇NCO, C₁₄H₂₉NCO, C₁₅H₃₁NCO, C₁₆H₃₃NCO, C₁₇H₃₅NCO, C₁₈H₃₇NCO, C₆F₁₃NCO, C₇F₁₅NCO, C₈F₁₇NCO, C₆H₁₂(NCO)₂, C₇F₁₄(NCO)₂, C₈H₁₆(NCO)₂, C₉H₁₈(NCO)₂, C₁₀H₂₀(NCO)₂, C₁₁H₂₂(NCO)₂, C₁₂H₂₄(NCO)₂, C₁₃H₂₆(NCO)₂, C₁₄H₂₈(NCO)₂, C₁₅H₃₀(NCO)₂, C₁₆H₃₂(NCO)₂, C₁₇H₃₄(NCO)₂, C₁₈H₃₆(NCO)₂, (NCO)C₆H₁₂NCO, (NCO)C₇H₁₄NCO, (NCO)C₈H₁₆NCO, (NCO)C₉H₁₈NCO, (NCO)C₁₀H₂₀NCO, (NCO)C₁₁H₂₂NCO, (NCO)C₁₂H₂₄NCO, (NCO)C₁₃H₂₆NCO, (NCO)C₁₄H₂₈NCO, (NCO)C₁₅H₃₀NCO, (NCO)C₁₆H₃₂NCO, (NCO)C₁₇H₃₄NCO, (NCO)C₁₈H₃₆NCO, C₁₀H₁₉(NCO)₃, C₁₁H₂₁(NCO)₃, C₁₂H₂₃(NCO)₃, C₁₃H₂₅(NCO)₃, C₁₄H₂₇(NCO)₃, C₁₅H₂₉(NCO)₃, C₁₆H₃₁(NCO)₃, C₁₇H₃₃(NCO)₃, C₁₈H₃₅(NCO)₃, (NCO)₂C₁₃H₂₄(NCO)₂, (NCO)₂C₁₄H₂₆(NCO)₂, (NCO)₂C₁₅H₂₈(NCO)₂, (NCO)₂C₁₆H₃₀(NCO)₂, (NCO)₂C₁₇H₃₂(NCO)₂, (NCO)₂C₁₈H₃₄(NCO)₂ and the like.

It is also possible to cite, for example, compounds such as C₆H₁₃COF, C₇H₁₅COF, C₈H₁₇COF, C₉H₁₉COF, C₁₀H₂₁COF, C₁₁H₂₃COF, C₁₂H₂₅COF, C₁₃H₂₇COF, C₁₄H₂₉COF, C₁₅H₃₁COF, C₁₆H₃₃COF, C₁₇H₃₅COF, C₁₈H₃₇COF, C₆H₅COF, C₆F₁₃COF, C₇F₁₅COF, C₈F₁₇COF, C₆H₁₃COCl, C₇H₁₅COCl, C₈H₁₇COCl, C₉H₁₉COCl, C₁₀H₂₁COCl, C₁₁H₂₃COCl, C₁₂H₂₅COCl, C₁₃H₂₇COCl, C₁₄H₂₉COCl, C₁₅H₃₁COCl, C₁₆H₃₃COCl, C₁₇H₃₅COCl, C₁₈H₃₇COCl, C₆H₅COCl, C₆F₁₃COCl, C₇F₁₅COCl, C₈F₁₇COCl, C₈H₁₇COBr, C₉H₁₉COBr, C₁₀H₂₁COBr, C₁₁H₂₃COBr, C₁₂H₂₅COBr, C₁₃H₂₇COBr, C₁₄H₂₉COBr, C₁₅H₃₁COBr, C₁₆H₃₃COBr, C₁₇H₃₅COBr, C₁₈H₃₇COBr, C₆F₁₃COBr, C₇F₁₅COBr, C₈F₁₇COBr, C₁₁H₂₃COI, C₁₂H₂₅COI, C₁₃H₂₇COI, C₁₄H₂₉COI, C₁₅H₃₁COI, C₁₆H₃₃COI, C₁₇H₃₅COI, C₁₈H₃₇COI, C₆F₁₃COI, C₇F₁₅COI, C₈F₁₇COI and the like.

It is also possible to cite, for example, compounds such as C₆H₁₃COOH, C₇H₁₅COOH, C₈H₁₇COOH, C₉H₁₉COOH, C₁₀H₂₁COOH, C₁₁H₂₃COOH, C₁₂H₂₅COOH, C₁₃H₂₇COOH, C₁₄H₂₉COOH, C₁₅H₃₁COOH, C₁₆H₃₃COOH, C₁₇H₃₅COOH, C₁₈H₃₇COOH, C₆H₅COOH, C₆F₁₃COOH, C₇F₁₅COOH, C₈F₁₇COOH, C₆H₁₃COOCH₃, C₇H₁₅COOCH₃, C₈H₁₇COOCH₃, C₉H₁₉COOCH₃, C₁₀H₂₁COOCH₃, C₁₁H₂₃COOCH₃, C₁₂H₂₅COOCH₃, C₁₃H₂₇COOCH₃, C₁₄H₂₉COOCH₃, C₁₅H₃₁COOCH₃, C₁₆H₃₃COOCH₃, C₁₇H₃₅COOCH₃, C₁₈H₃₇COOCH₃, C₆H₅COOCH₃, C₆F₁₃COOCH₃, C₇F₁₅COOCH₃, C₈F₁₇COOCH₃, C₆H₁₃COOC₂H₅, C₇H₁₅COOC₂H₅, C₈H₁₇COOC₂H₅, C₉H₁₉COOC₂H₅, C₁₀H₂₁COOC₂H₅, C₁₁H₂₃COOC₂H₅, C₁₂H₂₅COOC₂H₅, C₁₃H₂₇COOC₂H₅, C₁₄H₂₉COOC₂H₅, C₁₅H₃₁COOC₂H₅, C₁₆H₃₃COOC₂H₅, C₁₇H₃₅COOC₂H₅, C₁₈H₃₇COOC₂H₅, C₆H₅COOC₂H₅, C₆F₁₃COOC₂H₅, C₇F₁₅COOC₂H₅, C₈F₁₇COOC₂H₅, C₆H₁₃COOC₆H₅, C₇H₁₅COOC₆H₅, C₈H₁₇COOC₆H₅, C₉H₁₉COOC₆H₅, C₁₀H₂₁COOC₆H₅, C₁₁H₂₃COOC₆H₅, C₁₂H₂₅COOC₆H₅, C₁₃H₂₇COOC₆H₅, C₁₄H₂₉COOC₆H₅, C₁₅H₃₁COOC₆H₅, C₁₆H₃₃COOC₆H₅, C₁₇H₃₅COOC₆H₅, C₁₈H₃₇COOC₆H₅, C₆H₅COOC₆H₅, C₆F₁₃COOC₆H₅, C₇F₁₅COOC₆H₅, C₈F₁₇COOC₆H₅, C₆H₁₃COSH, C₇H₁₅COSH, C₈H₁₇COSH, C₉H₁₉COSH, C₁₀H₂₁COSH, C₁₁H₂₃COSH, C₁₂H₂₅COSH, C₁₃H₂₇COSH, C₁₄H₂₉COSH, C₁₅H₃₁COSH, C₁₆H₃₃COSH, C₁₇H₃₅COSH, C₁₈H₃₇COSH, C₆H₅COSH, C₆F₁₃COSH, C₇F₁₅COSH, C₈F₁₇COSH, C₆H₁₃COSCH₃, C₇H₁₅COSCH₃, C₈H₁₇COSCH₃, C₉H₁₉COSCH₃, C₁₀H₂₁COSCH₃, C₁₁H₂₃COSCH₃, C₁₂H₂₅COSCH₃, C₁₃H₂₇COSCH₃, C₁₄H₂₉COSCH₃, C₁₅H₃₁COSCH₃, C₁₆H₃₃COSCH₃, C₁₇H₃₅COSCH₃, C₁₈H₃₇COSCH₃, C₆H₅COSCH₃, C₆F₁₃COSCH₃, C₇F₁₅COSCH₃, C₈F₁₇COSCH₃ and the like.

It is also possible to cite, for example, compounds such as C₆H₁₃COOCOC₆H₁₃, C₇H₁₅COOCOC₇H₁₅, C₈H₁₇COOCOC₈H₁₇, C₉H₁₉COOCOC₉H₁₉, C₁₀H₂₁COOCOC₁₀H₂₁, C₁₁H₂₃COOCOC₁₁H₂₃, C₁₂H₂₅COOCOC₁₂H₂₅, C₁₃H₂₇COOCOC₁₃H₂₇, C₁₄H₂₉COOCOC₁₄H₂₉, C₁₅H₃₁COOCOC₁₅H₃₁, C₁₆H₃₃COOCOC₁₆H₃₃, C₁₇H₃₅COOCOC₁₇H₃₅, C₁₈H₃₇COOCOC₁₈H₃₇, C₆H₅COOCOC₆H₅, C₆F₁₃COOCOC₆F₁₃, C₇F₁₅COOCOC₇F₁₅, C₈F₁₇COOCOC₈F₁₇ and the like.

It is also possible to cite, for example, compounds such as C₆H₁₃SH, C₇H₁₅SH, C₈H₁₇SH, C₉H₁₉SH, C₁₀H₂₁SH, C₁₁H₂₃SH, C₁₂H₂₅SH, C₁₃H₂₇SH, C₁₄H₂₉SH, C₁₅H₃₁SH, C₁₆H₃₃SH, C₁₇H₃₅SH, C₁₈H₃₇SH, C₆F₁₃SH, C₇F₁₅SH, C₈F₁₇SH, C₆H₁₂(SH)₂, C₇H₁₄(SH)₂, C₈H₁₆(SH)₂, C₉H₁₈(SH)₂, C₁₀H₂₀(SH)₂, C₁₁H₂₂(SH)₂, C₁₂H₂₄(SH)₂, C₁₃H₂₆(SH)₂, C₁₄H₂₈(SH)₂, C₁₅H₃₀(SH)₂, C₁₆H₃₂(SH)₂, C₁₇H₃₄(SH)₂, C₁₈H₃₆(SH)₂, (SH)C₆H₁₂SH, (SH)C₇H₁₄SH, (SH)C₈H₁₆SH, (SH)C₉H₁₈SH, (SH)C₁₀H₂₀SH, (SH)C₁₁H₂₂SH, (SH)C₁₂H₂₄SH, (SH)C₁₃H₂₆SH, (SH)C₁₄H₂₈SH, (SH)C₁₅H₃₀SH, (SH)C₁₆H₃₂SH, (SH)C₁₇H₃₄SH, (SH)C₁₈H₃₆SH, C₈H₁₅(SH)₃, C₉H₁₇(SH)₃, C₁₀H₁₉(SH)₃, C₁₁H₂₁(SH)₃, C₁₂H₂₃(SH)₃, C₁₃H₂₅(SH)₃, C₁₄H₂₇(SH)₃, C₁₅H₂₉(SH)₃, C₁₆H₃₁(SH)₃, C₁₇H₃₃(SH)₃, C₁₈H₃₅(SH)₃, (SH)₂C₁₀H₁₈(SH)₂, (SH)₂C₁₁H₂₀(SH)₂, (SH)₂Cl₂H₂₂(SH)₂, (SH)₂C₁₃H₂₄(SH)₂, (SH)₂C₁₄H₂₆(SH)₂, (SH)₂C₁₅H₂₈(SH)₂, (SH)₂C₁₆H₃₀(SH)₂, (SH)₂C₁₇H₃₂(SH)₂, (SH)₂C₁₈H₃₄(SH)₂ and the like.

In the case where the surfactant forms a salt, the liquid chemical for forming a protective film may contain the surfactant, a salt thereof, and a mixture of these.

The surfactant preferably includes a hydrophobic moiety having a C₈-C₁₈ hydrocarbon group. As examples hydrocarbon group, it is possible to cite C₈H₁₇—, C₉H₁₉—, C₁₀H₂₁—, C₁₁H₂₃—, C₁₂H₂₅—, C₁₃H₂₇—, C₁₄H₂₉—, C₁₅H₃₁—, C₁₆H₃₃—, C₁₇H₃₅—, C₁₈H₃₇—, C₈F₁₇—, C₈Cl₁₇— and the like.

As the surfactant that includes a hydrophobic moiety having a C₈-C₁₈ hydrocarbon group, it is possible to cite, for example, compounds such as C₈H₁₇NH₂, C₉H₁₉NH₂, C₁₀H₂₁NH₂, C₁₁H₂₃NH₂, C₁₂H₂₅NH₂, C₁₃H₂₇NH₂, C₁₄H₂₉NH₂, C₁₅H₃₁NH₂, C₁₆H₃₃NH₂, C₁₇H₃₅NH₂, C₁₈H₃₇NH₂, C₈F₁₇NH₂, C₈Cl₁₇NH₂, C₈Br₁₇NH₂, C₈I₁₇NH₂, C₈F₁₅H₂NH₂, C₈Cl₁₅H₂NH₂, C₈Br₁₅H₂NH₂, C₈I₁₅H₂NH₂, (C₈H₁₇)₂NH, (C₉H₁₉)₂NH, (C₁₀H₂₁)₂NH, (C₁₁H₂₃)₂NH, (C₁₂H₂₅)₂NH, (C₁₃H₂₇)₂NH, (C₁₄H₂₉)₂NH, (C₁₅H₃₁)₂NH, (C₁₆H₃₃)₂NH, (C₁₇H₃₅)₂NH, (C₁₈H₃₇)₂NH, (C₈F₁₇)₂NH, (C₈Cl₁₇)₂NH, (C₈Br₁₇)₂NH, (C₈I₁₇)₂NH, (C₈F₁₅H₂)₂NH, (C₈Cl₁₅H₂)₂NH, (C₈Br₁₅H₂)₂NH, (C₈I₁₅H₂)₂NH, (C₈H₁₇)₃N, (C₉H₁₉)₃N, (C₁₀H₂₁)₃N, (C₁₁H₂₃)₃N, (C₁₂H₂₅)₃N, (C₁₃H₂₇)₃N, (C₁₄H₂₉)₃N, (C₁₅H₃₁)₃N, (C₁₆H₃₃)₃N, (C₁₇H₃₅)₃N, (C₁₈H₃₇)₃N, (C₈F₁₇)₃N, (C₈Cl₁₇)₃N, (C₈Br₁₇)₃N, (C₈I₁₇)₃N, (C₈F₁₅H₂)₃N, (C₈Cl₁₅H₂)₃N, (C₈Br₁₅H₂)₃N, (C₈I₁₅H₂)₃N, (C₈H₁₇)(CH₃)NH, (C₉H₁₉)(CH₃)NH, (C₁₀H₂₁)(CH₃)NH, (C₁₁H₂₃)(CH₃)NH, (C₁₂H₂₅)(CH₃)NH, (C₁₃H₂₇)(CH₃)NH, (C₁₄H₂₉)(CH₃)NH, (C₁₅H₃₁)(CH₃)NH, (C₁₆H₃₃)(CH₃)NH, (C₁₇H₃₅)(CH₃)NH, (C₁₈H₃₇)(CH₃)NH, (C₈F₁₇)(CH₃)NH, (C₈H₁₇)(CH₃)₂N, (C₉H₁₉)(CH₃)₂N, (C₁₀H₂₁)(CH₃)₂N, (C₁₁H₂₃)(CH₃)₂N, (C₁₂H₂₅)(CH₃)₂N, (C₁₃H₂₇)(CH₃)₂N, (C₁₄H₂₉)(CH₃)₂N, (C₁₅H₃₁)(CH₃)₂N, (C₁₆H₃₃)(CH₃)₂N, (C₁₇H₃₅)(CH₃)₂N, (C₁₈H₃₇)(CH₃)₂N, (C₈F₁₇)(CH₃)₂N and the like; inorganic acid salts of these, such as carbonates, hydrochlorides, sulfates, nitrates and the like; and organic acid salts of these, such as acetates, propionates, butyrates, phthalates and the like.

It is also possible to cite, for example, compounds such as C₈H₁₇NCO, C₉H₁₉NCO, C₁₀H₂₁NCO, C₁₁H₂₃NCO, C₁₂H₂₅NCO, C₁₃H₂₇NCO, C₁₄H₂₉NCO, C₁₅H₃₁NCO, C₁₆H₃₃NCO, C₁₇H₃₅NCO, C₁₈H₃₇NCO, C₈F₁₇NCO, C₈H₁₆(NCO)₂, C₉H₁₈(NCO)₂, C₁₀H₂₀(NCO)₂, C₁₁H₂₂(NCO)₂, C₁₂H₂₄(NCO)₂, C₁₃H₂₆(NCO)₂, C₁₄H₂₈(NCO)₂, C₁₅H₃₀(NCO)₂, C₁₆H₃₂(NCO)₂, C₁₇H₃₄(NCO)₂, C₁₈H₃₆(NCO)₂, (NCO)C₈H₁₆NCO, (NCO)C₉H₁₈NCO, (NCO)C₁₀H₂₀NCO, (NCO)C₁₁H₂₂NCO, (NCO)C₁₂H₂₄NCO, (NCO)C₁₃H₂₆NCO, (NCO)C₁₄H₂₈NCO, (NCO)C₁₅H₃₀NCO, (NCO)C₁₆H₃₂NCO, (NCO)C₁₇H₃₄NCO, (NCO)C₁₈H₃₆NCO, C₁₀H₁₉(NCO)₃, C₁₁H₂₁(NCO)₃, C₁₂H₂₃(NCO)₃, C₁₃H₂₅(NCO)₃, C₁₄H₂₇(NCO)₃, C₁₅H₂₉(NCO)₃, C₁₆H₃₁(NCO)₃, C₁₇H₃₃(NCO)₃, C₁₈H₃₅(NCO)₃, (NCO)₂C₁₃H₂₄(NCO)₂, (NCO)₂C₁₄H₂₆(NCO)₂, (NCO)₂C₁₅H₂₈(NCO)₂, (NCO)₂C₁₆H₃₀(NCO)₂, (NCO)₂C₁₇H₃₂(NCO)₂, (NCO)₂C₁₈H₃₄(NCO)₂ and the like.

It is also possible to cite, for example, compounds such as C₈H₁₇COF, C₉H₁₉COF, C₁₀H₂₁COF, C₁₁H₂₃COF, C₁₂H₂₅COF, C₁₃H₂₇COF, C₁₄H₂₉COF, C₁₅H₃₁COF, C₁₆H₃₃COF, C₁₇H₃₅COF, C₁₈H₃₇COF, C₈F₁₇COF, C₈H₁₇COCl, C₉H₁₉COCl, C₁₀H₂₁COCl, C₁₁H₂₃COCl, C₁₂H₂₅COCl, C₁₃H₂₇COCl, C₁₄H₂₉COCl, C₁₅H₃₁COCl, C₁₆H₃₃COCl, C₁₇H₃₅COCl, C₁₈H₃₇COCl, C₈F₁₇COCl, C₈H₁₇COBr, C₉H₁₉COBr, C₁₀H₂₁COBr, C₁₁H₂₃COBr, C₁₂H₂₅COBr, C₁₃H₂₇COBr, C₁₄H₂₉COBr, C₁₅H₃₁COBr, C₁₆H₃₃COBr, C₁₇H₃₅COBr, C₁₈H₃₇COBr, C₈F₁₇COBr, C₁₁H₂₃COI, C₁₂H₂₅COI, C₁₃H₂₇COI, C₁₄H₂₉COI, C₁₅H₃₁COI, C₁₆H₃₃COI, C₁₇H₃₅COI, C₁₈H₃₇COI, C₈F₁₇COI and the like.

It is also possible to cite, for example, compounds such as C₈H₁₇COOH, C₉H₁₉COOH, C₁₀H₂₁COOH, C₁₁H₂₃COOH, C₁₂H₂₅COOH, C₁₃H₂₇COOH, C₁₄H₂₉COOH, C₁₅H₃₁COOH, C₁₆H₃₃COOH, C₁₇H₃₅COOH, C₁₈H₃₇COOH, C₈F₁₇COOH, C₈H₁₇COOCH₃, C₉H₁₉COOCH₃, C₁₀H₂₁COOCH₃, C₁₁H₂₃COOCH₃, C₁₂H₂₅COOCH₃, C₁₃H₂₇COOCH₃, C₁₄H₂₉COOCH₃, C₁₅H₃₁COOCH₃, C₁₆H₃₃COOCH₃, C₁₇H₃₅COOCH₃, C₁₈H₃₇COOCH₃, C₈F₁₇COOCH₃, C₈H₁₇COOC₂H₅, C₉H₁₉COOC₂H₅, C₁₀H₂₁COOC₂H₅, C₁₁H₂₃COOC₂H₅, C₁₂H₂₅COOC₂H₅, C₁₃H₂₇COOC₂H₅, C₁₄H₂₉COOC₂H₅, C₁₅H₃₁COOC₂H₅, C₁₆H₃₃COOC₂H₅, C₁₇H₃₅COOC₂H₅, C₁₈H₃₇COOC₂H₅, C₈F₁₇COOC₂H₅, C₈H₁₇COOC₆H₅, C₉H₁₉COOC₆H₅, C₁₀H₂₁COOC₆H₅, C₁₁H₂₃COOC₆H₅, C₁₂H₂₅COOC₆H₅, C₁₃H₂₇COOC₆H₅, C₁₄H₂₉COOC₆H₅, C₁₅H₃₁COOC₆H₅, C₁₆H₃₃COOC₆H₅, C₁₇H₃₅COOC₆H₅, C₁₈H₃₇COOC₆H₅, C₈F₁₇COOC₆H₅, C₈H₁₇COSH, C₉H₁₉COSH, C₁₀H₂₁COSH, C₁₁H₂₃COSH, C₁₂H₂₅COSH, C₁₃H₂₇COSH, C₁₄H₂₉COSH, C₁₅H₃₁COSH, C₁₆H₃₃COSH, C₁₇H₃₅COSH, C₁₈H₃₇COSH, C₈F₁₇COSH, C₈H₁₇COSCH₃, C₉H₁₉COSCH₃, C₁₀H₂₁COSCH₃, C₁₁H₂₃COSCH₃, C₁₂H₂₅COSCH₃, C₁₃H₂₇COSCH₃, C₁₄H₂₉COSCH₃, C₁₅H₃₁COSCH₃, C₁₆H₃₃COSCH₃, C₁₇H₃₅COSCH₃, C₁₈H₃₇COSCH₃, C₈F₁₇COSCH₃ and the like.

It is also possible to cite, for example, compounds such as C₈H₁₇COOCOC₈H₁₇, C₉H₁₉COOCOC₉H₁₉, C₁₀H₂₁COOCOC₁₀H₂₁, C₁₁H₂₃COOCOC₁₁H₂₃, C₁₂H₂₅COOCOC₁₂H₂₅, C₁₃H₂₇COOCOC₁₃H₂₇, C₁₄H₂₉COOCOC₁₄H₂₉, C₁₅H₃₁COOCOC₁₅H₃₁, C₁₆H₃₃COOCOC₁₆H₃₃, C₁₇H₃₅COOCOC₁₇H₃₅, C₁₈H₃₇COOCOC₁₈H₃₇, C₈F₁₇COOCOC₈F₁₇ and the like.

It is also possible to cite, for example, compounds such as C₈H₁₇SH, C₉H₁₉SH, C₁₀H₂₁SH, C₁₁H₂₃SH, C₁₂H₂₅SH, C₁₃H₂₇SH, C₁₄H₂₉SH, C₁₅H₃₁SH, C₁₆H₃₃SH, C₁₇H₃₅SH, C₁₈H₃₇SH, C₈F₁₇SH, C₈H₁₆(SH)₂, C₉H₁₈(SH)₂, C₁₀H₂₀(SH)₂, C₁₁H₂₂(SH)₂, C₁₂H₂₄(SH)₂, C₁₃H₂₆(SH)₂, C₁₄H₂₈(SH)₂, C₁₅H₃₀(SH)₂, C₁₆H₃₂(SH)₂, C₁₇H₃₄(SH)₂, C₁₈H₃₆(SH)₂, (SH)C₈H₁₆SH, (SH)C₉H₁₈SH, (SH)C₁₀H₂₀SH, (SH)C₁₁H₂₂SH, (SH)C₁₂H₂₄SH, (SH)C₁₃H₂₆SH, (SH)C₁₄H₂₈SH, (SH)C₁₅H₃₀SH, (SH)C₁₆H₃₂SH, (SH)C₁₇H₃₄SH, (SH)C₁₈H₃₆SH, C₈H₁₅(SH)₃, C₉H₁₇(SH)₃, C₁₀H₁₉(SH)₃, C₁₁H₂₁(SH)₃, C₁₂H₂₃(SH)₃, C₁₃H₂₅(SH)₃, C₁₄H₂₇(SH)₃, C₁₅H₂₉(SH)₃, C₁₆H₃₁(SH)₃, C₁₇H₃₃(SH)₃, C₁₈H₃₅(SH)₃, (SH)₂C₁₀H₁₈(SH)₂, (SH)₂C₁₁H₂₀(SH)₂, (SH)₂Cl₂H₂₂(SH)₂, (SH)₂C₁₃H₂₄(SH)₂, (SH)₂C₁₄H₂₆(SH)₂, (SH)₂C₁₅H₂₈(SH)₂, (SH)₂C₁₆H₃₀(SH)₂, (SH)₂C₁₇H₃₂(SH)₂, (SH)₂C₁₈H₃₄(SH)₂ and the like.

Of these surfactants, one that includes amino group as the functional group having an affinity with metal-based materials is preferable.

Moreover, in the liquid chemical for forming a protective film, the surfactant is contained to have a concentration of not smaller than 0.00001 mass % relative to 100 mass % of the total amount of the liquid chemical and not larger than the saturated concentration. Within such a concentration range, the protective film is more readily and evenly formed at least on the surfaces of the recessed portions of the uneven pattern. When the surfactant has a concentration of smaller than 0.00001 mass %, the effect of imparting water repellency to the surface of the metal-based wafer tends to be insufficient. The concentration is more preferably not smaller than 0.00003 mass %. If the concentration exceeds the saturated concentration, the surfactant in the mixture liquid forms a micelle to cause emulsification or to cause phase separation into a phase having a concentration of not larger than the saturated concentration and a phase in which the surfactant exists at a high concentration, which makes the liquid chemical into an inhomogeneous one. Alternatively, it can become the cause of particles. Hence the concentration of the surfactant is not larger than the saturated concentration. However, a liquid chemical that has caused phase separation may be used upon extracting only the phase having a concentration of not larger than the saturated concentration, as the liquid chemical for forming a protective film.

Additionally, the liquid chemical for forming a protective film may contain a solvent other than water. It is possible to use the solvent upon mixing it with water to have a concentration not larger than the saturated solubility. Usable examples of the above-mentioned solvent include hydrocarbons, esters, ethers, ketones, halogen element-containing solvents, sulfoxide-based solvents, alcohols, polyalcohol derivatives and nitrogen element-containing solvents, and mixture liquids of these. Examples of hydrocarbons are toluene, benzene, xylene, hexane, heptane, octane and the like. Examples of esters are ethyl acetate, propyl acetate, butyl acetate, ethyl acetoacetate and the like. Examples of ethers are diethyl ether, dipropyl ether, dibutyl ether, tetrahydrofuran, dioxane and the like. Examples of ketones are acetone, acetylacetone, methyl ethyl ketone, methyl propyl ketone, methyl butyl ketone, cyclohexanone and the like. Examples of the halogen element-containing solvents are: perfluorocarbons such as perfluorooctane, perfluorononane, perfluorocyclopentane, perfluorocyclohexane, hexafluorobenzene and the like; hydrofluorocarbons such as 1,1,1,3,3-pentafluorobutane, octafluorocyclopentane, 2,3-dihydrodecafluoropentane, ZEORORA-H (produced by ZEON CORPORATION) and the like; hydrofluoroethers such as methyl perfluoroisobutyl ether, methyl perfluorobutyl ether, ethyl perfluorobutyl ether, ethyl perfluoroisobutyl ether, ASAHIKLIN AE-3000 (produced by Asahi Glass Co., Ltd.), Novec HFE-7100, Novec HFE-7200, Novec 7300, Novec 7600 (any of these are produced by 3M Limited) and the like; chlorocarbons such as tetrachloromethane and the like; hydrochlorocarbons such as chloroform and the like; chlorofluorocarbons such as dichlorodifluoromethane and the like; hydrochlorofluorocarbons such as 1,1-dichloro-2,2,3,3,3-pentafluoropropane, 1,3-dichloro-1,1,2,2,3-pentafluoropropane, 1-chloro-3,3,3-trifluoropropene, 1,2-dichloro-3,3,3-trifluoropropene and the like; perfluoroethers; perfluoropolyethers; and the like. Examples of the sulfoxide-based solvents are dimethyl sulfoxide and the like. Examples of alcohols are methanol, ethanol, propanol, butanol, ethylene glycol, 1,3-propanediol and the like. Examples of the polyalcohol derivatives are diethylene glycol monoethyl ether, ethylene glycol monomethyl ether, ethylene glycol monobutyl ether, propylene glycol monomethyl ether, propylene glycol monoethyl ether, diethylene glycol monoethyl ether acetate, ethylene glycol monomethyl ether acetate, ethylene glycol monobutyl ether acetate, propylene glycol monomethyl ether acetate, propylene glycol monoethyl ether acetate, diethylene glycol dimethyl ether, diethylene glycol ethyl methyl ether, diethylene glycol diethyl ether, diethylene glycol monomethyl ether acetate, diethylene glycol diacetate, triethylene glycol dimethyl ether, triethylene glycol diethyl ether, dipropylene glycol dimethyl ether, ethylene glycol diacetate, ethylene glycol diethyl ether, ethylene glycol dimethyl ether and the like. Examples of the nitrogen element-containing solvents are formamide, N,N-dimethylformamide, N,N-dimethylacetamide, N-methyl-2-pyrrolidone, diethylamine, triethylamine, pyridine and the like.

Hereinafter, the step 1 will be discussed. First of all, a resist is applied to a surface of a wafer and then the resist is exposed to light through a resist mask, followed by conducting an etching removal on the exposed resist or on an unexposed resist thereby producing a resist having a desired uneven pattern. Additionally, the resist having an uneven pattern can be obtained also by pushing a mold having a pattern onto the resist. Then, etching is conducted on the wafer. At this time, the wafer surface corresponding to the recessed portions of the resist pattern are etched selectively. Finally, the resist is stripped off thereby obtaining a wafer having an uneven pattern.

Incidentally, as the metal-based wafer, it is possible to cite: those obtained by coating a surface of a silicon wafer, a wafer formed of a plurality of components including silicon and/or silicon oxide (SiO₂), a silicon carbide wafer, a sapphire wafer, various compound semiconductor wafers, a plastic wafer or the like with a layer formed of a material containing at least one kind of element selected from the group consisting of titanium, tungsten, aluminum, copper, tin, tantalum and ruthenium, more preferably at least one kind of element selected from the group consisting of tungsten, aluminum and ruthenium; those in which at least one layer of a multilayer film formed on the wafer is a layer formed of the above-mentioned metal-based material; and the like. The above-mentioned step of forming an uneven pattern is conducted in the layer containing a layer formed of the metal-based material. Additionally, there are also included those in which at least a part of the surfaces of the recessed portions of the surface of the uneven pattern serves as the metal-based material at the time of forming the uneven pattern.

The metal-based material is exemplified by: a matter containing titanium element, such as titanium nitride, titanium oxide, titanium and the like; a matter containing tungsten element, such as tungsten, tungsten oxide and the like; a matter containing aluminum element, such as aluminum, aluminum oxide and the like; a matter containing copper element, such as copper, copper oxide and the like; a matter containing tin element, such as tin, tin oxide and the like; a matter containing tantalum element, such as tantalum, tantalum oxide, tantalum nitride and the like; and a matter containing ruthenium element, such as ruthenium, ruthenium oxide and the like.

Additionally, also concerning a wafer formed of a plurality of components including the metal-based material, it is possible to form the protective film on the surface of the metal-based material. Examples of the wafer formed of a plurality of components are: those in which the metal-based material is formed at least at a part of the surfaces of the recessed portions; and those in which at least a part of the surfaces of the recessed portions serves as the metal-based material at the time of forming the uneven pattern. Incidentally, where the protective film can be formed by the liquid chemical of the present invention is at least on a surface of a portion formed of the metal-based material, in the uneven pattern. Accordingly, the protective film may be such as to be formed at least on a part of the surfaces of the recessed portions of the metal-based wafer.

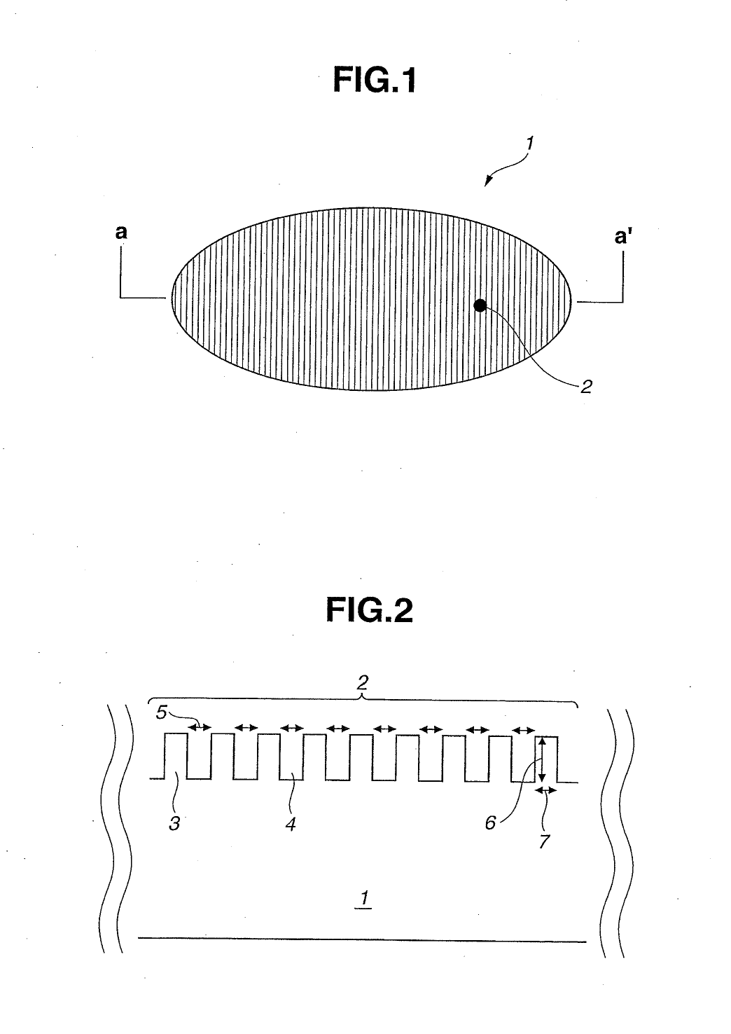

The wafer surface is cleaned with the water-based cleaning liquid in the step 2, and then the water-based cleaning liquid is removed by drying or water is removed by drying or the like after substituting the water-based cleaning liquid with water. If the recessed portions have a small width and projected portions have a large aspect ratio at this time, the pattern collapse is to easily occur. The uneven pattern is defined as shown in FIG. 1 and FIG. 2. FIG. 1 is a schematic plan view of a wafer 1 whose surface is made into a surface having an uneven pattern 2. FIG. 2 is a view showing a part of a-a′ cross section of FIG. 1. A width 5 of recessed portions is defined by an interval between adjacent projected portions 3, as shown in FIG. 2. The aspect ratio of projected portions is expressed by dividing a height 6 of the projected portions by a width 7 of the projected portions. The pattern collapse in the cleaning step is to easily occur when the recessed portions have a width of not more than 70 nm, particularly not more than 45 nm and when the aspect ratio is not less than 4, particularly not less than 6.

In the preferable embodiment of the present invention, the wafer surface is made into a surface having an uneven pattern as discussed in the step 1, followed by supplying the water-based cleaning liquid to the surface in the step 2 thereby retaining the water-based cleaning liquid at least on the surfaces of the recessed portions of the uneven pattern. Thereafter, the water-based cleaning liquid retained at least on the surfaces of the recessed portions of the uneven pattern is substituted with the cleaning liquid (A) different from the water-based cleaning liquid, as discussed in the step 3. As preferable examples of the cleaning liquid (A), it is possible to cite the liquid chemical for forming a protective film specified by the present invention, water, an organic solvent, a mixture of these, a mixture of these and at least one kind of acids, alkalis and surfactants, and the like. If one other than the liquid chemical is used as the cleaning liquid (A), it is preferable to substitute the cleaning liquid (A) with the liquid chemical under a condition where the cleaning liquid (A) is retained at least on the surfaces of the recessed portions of the uneven pattern.

Moreover, as examples of the organic solvent which is a preferable example of the cleaning liquid (A), it is possible to cite hydrocarbons, esters, ethers, ketones, halogen element-containing solvents, sulfoxide-based solvents, alcohols, polyalcohol derivatives and nitrogen element-containing solvents and the like.

Examples of hydrocarbons are toluene, benzene, xylene, hexane, heptane, octane and the like. Examples of esters are ethyl acetate, propyl acetate, butyl acetate, ethyl acetoacetate and the like. Examples of ethers are diethyl ether, dipropyl ether, dibutyl ether, tetrahydrofuran, dioxane and the like. Examples of ketones are acetone, acetylacetone, methyl ethyl ketone, methyl propyl ketone, methyl butyl ketone, cyclohexanone and the like. Examples of the halogen element-containing solvents are: perfluorocarbons such as perfluorooctane, perfluorononane, perfluorocyclopentane, perfluorocyclohexane, hexafluorobenzene and the like; hydrofluorocarbons such as 1,1,1,3,3-pentafluorobutane, octafluorocyclopentane, 2,3-dihydrodecafluoropentane, ZEORORA-H (produced by ZEON CORPORATION) and the like; hydrofluoroethers such as methyl perfluoroisobutyl ether, methyl perfluorobutyl ether, ethyl perfluorobutyl ether, ethyl perfluoroisobutyl ether, ASAHIKLIN AE-3000 (produced by Asahi Glass Co., Ltd.), Novec HFE-7100, Novec HFE-7200, Novec 7300, Novec 7600 (any of these are produced by 3M Limited) and the like; chlorocarbons such as tetrachloromethane and the like; hydrochlorocarbons such as chloroform and the like; chlorofluorocarbons such as dichlorodifluoromethane and the like; hydrochlorofluorocarbons such as 1,1-dichloro-2,2,3,3,3-pentafluoropropane, 1,3-dichloro-1,1,2,2,3-pentafluoropropane, 1-chloro-3,3,3-trifluoropropene, 1,2-dichloro-3,3,3-trifluoropropene and the like; perfluoroethers; perfluoropolyethers; and the like. Examples of the sulfoxide-based solvents are dimethyl sulfoxide and the like. Examples of alcohols are methanol, ethanol, propanol, butanol, ethylene glycol, 1,3-propanediol and the like. Examples of the polyalcohol derivatives are diethylene glycol monoethyl ether, ethylene glycol monomethyl ether, ethylene glycol monobutyl ether, propylene glycol monomethyl ether, propylene glycol monoethyl ether, diethylene glycol monoethyl ether acetate, ethylene glycol monomethyl ether acetate, ethylene glycol monobutyl ether acetate, propylene glycol monomethyl ether acetate, propylene glycol monoethyl ether acetate, diethylene glycol dimethyl ether, diethylene glycol ethyl methyl ether, diethylene glycol diethyl ether, diethylene glycol monomethyl ether acetate, diethylene glycol diacetate, triethylene glycol dimethyl ether, triethylene glycol diethyl ether, dipropylene glycol dimethyl ether, ethylene glycol diacetate, ethylene glycol diethyl ether, ethylene glycol dimethyl ether and the like. Examples of the nitrogen element-containing solvents are formamide, N,N-dimethylformamide, N,N-dimethylacetamide, N-methyl-2-pyrrolidone, diethylamine, triethylamine, pyridine and the like.

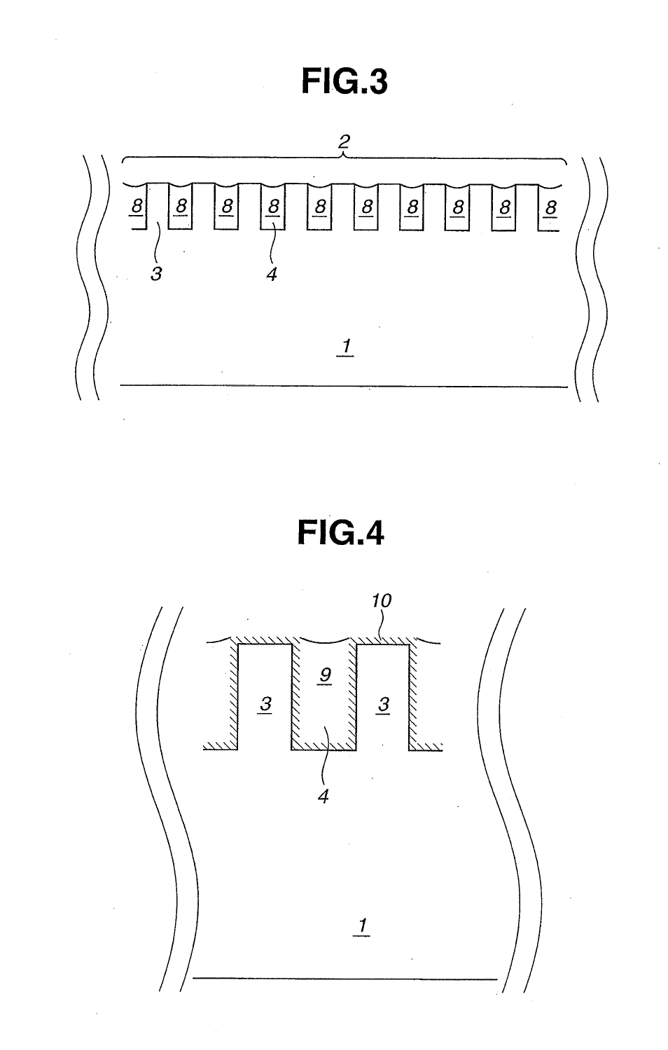

FIG. 3 is a schematic view showing a condition where a liquid chemical 8 for forming a protective film is retained in recessed portions 4 in the step of forming a protective film at least on the surfaces of the recessed portions of the uneven pattern by using the liquid chemical for forming a protective film. The wafer of the schematic view of FIG. 3 shows a part of the a-a′ cross section in FIG. 1. At this time, a protective film is formed on the surfaces of the recessed portions 4 thereby imparting water repellency to the surfaces.

When the temperature of the liquid chemical for forming a protective film is increased, the protective film tends to be formed in a shorter time. A temperature at which the protective film can easily and evenly be formed is from 10 to 160° C. Particularly, the liquid chemical is preferably retained at 15 to 120° C. It is preferable that the temperature of the liquid chemical is kept at the above-mentioned temperature even while the liquid chemical is retained at least on the surfaces of the recessed portions of the uneven pattern.

After the step of retaining the liquid chemical for forming a protective film at least on the surfaces of the recessed portions of the uneven pattern (the step 4), the liquid chemical retained at least on the surfaces of the recessed portions of the uneven pattern may be substituted with the cleaning liquid (B) different from the liquid chemical, and the step of removing a liquid formed of the cleaning liquid and/or the liquid chemical from the surfaces of the uneven pattern by drying (the step 5) may be performed thereafter. Examples of the cleaning liquid (B) are a water-based cleaning liquid formed of a water-based solution, an organic solvent, a mixture of the water-based cleaning liquid and an organic solvent, a liquid obtained by adding at least one kind of acids, alkalis and surfactants to these, a liquid into which the surfactant contained in the liquid chemical for forming a protective film is incorporated to have a concentration lower than that of the liquid chemical, and the like.

Moreover, as examples of the organic solvent which is a preferable example of the cleaning liquid (B), it is possible to cite hydrocarbons, esters, ethers, ketones, halogen element-containing solvents, sulfoxide-based solvents, alcohols, polyalcohol derivatives and nitrogen element-containing solvents and the like.

Examples of hydrocarbons are toluene, benzene, xylene, hexane, heptane, octane and the like. Examples of esters are ethyl acetate, propyl acetate, butyl acetate, ethyl acetoacetate and the like. Examples of ethers are diethyl ether, dipropyl ether, dibutyl ether, tetrahydrofuran, dioxane and the like. Examples of ketones are acetone, acetylacetone, methyl ethyl ketone, methyl propyl ketone, methyl butyl ketone, cyclohexanone and the like. Examples of the halogen element-containing solvents are: perfluorocarbons such as perfluorooctane, perfluorononane, perfluorocyclopentane, perfluorocyclohexane, hexafluorobenzene and the like; hydrofluorocarbons such as 1,1,1,3,3-pentafluorobutane, octafluorocyclopentane, 2,3-dihydrodecafluoropentane, ZEORORA-H (produced by ZEON CORPORATION) and the like; hydrofluoroethers such as methyl perfluoroisobutyl ether, methyl perfluorobutyl ether, ethyl perfluorobutyl ether, ethyl perfluoroisobutyl ether, ASAHIKLIN AE-3000 (produced by Asahi Glass Co., Ltd.), Novec HFE-7100, Novec HFE-7200, Novec 7300, Novec 7600 (any of these are produced by 3M Limited) and the like; chlorocarbons such as tetrachloromethane and the like; hydrochlorocarbons such as chloroform and the like; chlorofluorocarbons such as dichlorodifluoromethane and the like; hydrochlorofluorocarbons such as 1,1-dichloro-2,2,3,3,3-pentafluoropropane, 1,3-dichloro-1,1,2,2,3-pentafluoropropane, 1-chloro-3,3,3-trifluoropropene, 1,2-dichloro-3,3,3-trifluoropropene and the like; perfluoroethers; perfluoropolyethers; and the like. Examples of the sulfoxide-based solvents are dimethyl sulfoxide and the like. Examples of alcohols are methanol, ethanol, propanol, butanol, ethylene glycol, 1,3-propanediol and the like. Examples of the polyalcohol derivatives are diethylene glycol monoethyl ether, ethylene glycol monomethyl ether, ethylene glycol monobutyl ether, propylene glycol monomethyl ether, propylene glycol monoethyl ether, diethylene glycol monoethyl ether acetate, ethylene glycol monomethyl ether acetate, ethylene glycol monobutyl ether acetate, propylene glycol monomethyl ether acetate, propylene glycol monoethyl ether acetate, diethylene glycol dimethyl ether, diethylene glycol ethyl methyl ether, diethylene glycol diethyl ether, diethylene glycol monomethyl ether acetate, diethylene glycol diacetate, triethylene glycol dimethyl ether, triethylene glycol diethyl ether, dipropylene glycol dimethyl ether, ethylene glycol diacetate, ethylene glycol diethyl ether, ethylene glycol dimethyl ether and the like. Examples of the nitrogen element-containing solvents are formamide, N,N-dimethylformamide, N,N-dimethylacetamide, N-methyl-2-pyrrolidone, diethylamine, triethylamine, pyridine and the like.

After going through the substitution with the cleaning liquid (B) thereby retaining a water-based cleaning liquid formed of a water-based solution at least on the surfaces of the recessed portions of the uneven pattern, the step 5 may be performed. In order to more greatly maintain the water repellency of the protective film formed on the surfaces of the uneven pattern, it is preferable to shift to the step 5 after substituting the liquid chemical retained at least on the surfaces of the recessed portions of the uneven pattern with the cleaning liquid (B) different from the liquid chemical. Alternatively, it is more preferable to directly shift to the step 5 after the step of retaining the liquid chemical for forming a protective film at least on the surfaces of the recessed portions of the uneven pattern (the step 4).

Examples of the water-based cleaning liquid are water and liquids containing water as the primary component (for example, liquids having a 50 mass % or more water content), the liquids being obtained by mixing at least one kind of an organic solvent, acid and alkali into water. It is particularly preferable to use water as the water-based cleaning liquid, since the contact angle to a liquid retained at least on the surfaces of the recessed portions of the uneven pattern which surfaces are provided with water repellency by the above-mentioned liquid chemical is so increased as to decrease the capillary force “P” and since stain comes to hardly remain on the surface of the wafer after drying.

A schematic view showing a case where a liquid formed of the cleaning liquid and/or the liquid chemical is retained in recessed portions 4 provided with water repellency by the liquid chemical for forming a protective film is shown in FIG. 4. The wafer as shown in the schematic view of FIG. 4 shows a part of an a-a′ cross section of FIG. 1. On the surfaces of an uneven pattern, a protective film 10 is formed and provided with water repellency by liquid chemical for forming a protective film. The protective film 10 is retained on the surface of the wafer even when the liquid 9 is removed from the uneven pattern.

When the protective film 10 is formed at least on the surfaces of the recessed portions of the uneven pattern of the wafer by the liquid chemical for forming a protective film, a contact angle of from 50 to 130° is preferable on the assumption that water is retained on the surface, because the pattern collapse becomes difficult to occur. The closer to 90° the contact angle is, the smaller the capillary force that acts on the recessed portions becomes, which makes the pattern collapse further difficult to occur and therefore the contact angle of from 70 to 110° is particularly preferable. Additionally, the capillary force of not higher than 2.1 MN/m² is preferable because the pattern collapse becomes difficult to occur. Additionally, a lower capillary force makes the pattern collapse further difficult to occur, so that a capillary force of not higher than 1.1 MN/m² is particularly preferable. Furthermore, it is ideal to put the capillary force close to 0.0 MN/m² as much as possible by adjusting the contact angle to the liquid to around 90°.

Incidentally, the subsequent cleaning step may be skipped if possible. If the concentration of the surfactant in the liquid chemical for forming a protective film of the present invention is within the above-mentioned range, residues of the protective film are made difficult to remain on the wafer surface after the step of removing the film; therefore it is easy to skip the subsequent cleaning step and results in simplification of the steps.

In the case of skipping the subsequent cleaning step, the higher the water concentration relative to the total amount of the solvent contained in the liquid chemical for forming a protective film is, the larger the contact angle of the liquid chemical for forming a protective film to the surface obtained after forming a protective film becomes. Hence the capillary force which is to act on the recessed portions can be easily decreased. As a result, the pattern collapse becomes difficult to occur at the time of removing the liquid chemical, which is preferable. Accordingly, the concentration of water relative to the total amount of the solvent contained in the liquid chemical for forming a protective film is preferably not lower than 70 mass %, more preferably not lower than 85 mass %. Furthermore, it is particularly preferable that the solvent is fully formed of water.

As discussed above (as the step 5), there will be conducted a step of removing a liquid formed of the cleaning liquid and/or the liquid chemical from the surfaces of the uneven pattern by drying. The liquid retained in the recessed portions at this time may be the liquid chemical, the cleaning liquid (B), the water-based cleaning liquid or a mixture liquid of these. Incidentally, a mixture liquid containing the surfactant is a liquid in which the surfactant contained in the liquid chemical has a lower concentration than the liquid chemical, and may be a liquid in which the liquid chemical is on the way to substitution with the cleaning liquid (B), or may be a mixture liquid obtained by previously mixing the surfactant with the cleaning liquid (B). From the viewpoint of cleanliness of the wafer, it is particularly preferable to use water, an organic solvent or a mixture of water and an organic solvent. Moreover, after the liquid is once removed from the unevenly patterned surface, it is possible to retain the cleaning liquid (B) on the unevenly patterned surface, followed by drying.

In the drying step, the liquid formed of the cleaning liquid and/or the liquid chemical which liquid had been retained on the unevenly patterned surface is removed by drying. The drying step is preferably conducted by a conventionally known drying method such as spin drying, IPA (2-propanol) steam drying, Marangoni drying, heating drying, warm air drying, vacuum drying and the like.

Next, there will be performed a step of removing a protective film, as discussed above (as the step 6). At the time of removing the water repellent protective film, it is effective to cleave C—C bond and C—F bond in the water repellent protective film. A method therefor is not particularly limited so long as it is possible to cleave the above-mentioned bonds, and exemplified by: irradiating the wafer surface with light; heating the wafer; exposing the wafer to ozone; irradiating the wafer surface with plasma; subjecting the wafer surface to corona discharge; and the like.

In the case of removing the protective film by light irradiation, it is preferable to conduct an irradiation with ultraviolet rays having a wavelength of shorter than 340 nm and 240 nm (corresponding to bond energies of C—C bond and C—F bond, i.e., 83 kcal/mol and 116 kcal/mol, respectively). As the light source therefor, there is used a metal halide lamp, a low-pressure mercury lamp, a high-pressure mercury lamp, an excimer lamp, a carbon arc or the like. In the case of using the metal halide lamp, the intensity of the ultraviolet irradiation is preferably not less than 100 mW/cm², particularly preferably not less than 200 mW/cm², as a measurement value obtained by the illuminance meter (Intensity meter UM-10 produced by Konica Minolta Sensing, Inc., Light-Receptor UM-360 [Peak sensitivity wavelength: 365 nm, Measured wavelength range: 310 to 400 nm]). Incidentally, an irradiation intensity of less than 100 mW/cm² takes a long time to remove the protective film 10. Additionally, in the case of using the low-pressure mercury lamp, the ultraviolet irradiation is performed with shorter wavelengths so that removal of the protective film is achieved in a short time even if the intensity is low, which is therefore preferable.

Additionally, in the case of removing the protective film by light irradiation, it is particularly preferable to generate ozone in parallel with decomposing the components of the protective film by ultraviolet rays and then to induce oxidation-volatilization of the components of the protective film by the ozone, since a treatment time is saved thereby. As the light source therefor, the low-pressure mercury lamp, the excimer lamp or the like is used. Moreover, the wafer may be heated while being subjected to light irradiation.

In the case where the wafer is heated, the heating of the wafer is conducted at 400 to 700° C., preferably at 500 to 700° C. The heating time is preferably kept for 1 to 60 minutes, more preferably for 10 to 30 minutes. Additionally, this step may be conducted in combination with ozone exposure, plasma irradiation, corona discharge or the like. Furthermore, the light irradiation may be conducted while heating the wafer.

A method for removing the protective film by heating is exemplified by a method of bringing a wafer into contact with a heat source, a method of setting a wafer aside in a heated atmosphere such as a heat treat furnace and the like, and the like. Incidentally, the method of setting a wafer aside in a heated atmosphere can easily and evenly impart energy for removing the protective film to the wafer surface even in the case of treating the plural sheets of wafers, and therefore serves as an industrially advantageous method with simple operations, a short treatment time and a high treatment capacity.

In the case of exposing the wafer to ozone, it is preferable to expose the wafer surface to ozone generated by ultraviolet irradiation using the low-pressure mercury lamp, low-temperature discharge using high voltages or the like. The wafer may be irradiated with light or heated while being exposed to ozone.

In the step of removing the film, the protective film on the wafer surface can be efficiently removed by combining the light irradiation, the heating, the ozone exposure, the plasma irradiation, the corona discharge and the like.

### EXAMPLES

A technique of making a surface of a wafer into a surface having an uneven pattern and a technique of substituting a cleaning liquid retained at least in recessed portions of the uneven pattern with another cleaning liquid have been variously studied as discussed in other literatures and the like, and have already been established. Accordingly, in Examples of the present invention, there were mainly performed evaluations concerning a liquid chemical for forming a protective film. Additionally, as apparent from the following equation:

P=2×γ×cos θ/S

(In the equation, γ represents the surface tension of a liquid retained in the recessed portions, θ represents the contact angle of the liquid retained in the recessed portions to the surfaces of the recessed portions, and S represents the width of the recessed portions),

a pattern collapse greatly depends on the contact angle of a cleaning liquid to the surface of the wafer, i.e. the contact angle of a liquid drop, and on the surface tension of the cleaning liquid. In the case of a cleaning liquid retained in recessed portions 4 of an uneven pattern 2, the contact angle of a liquid drop and the capillary force acting on the recessed portions (which force can be regarded as being equal to the pattern collapse) are in correlation with each other, so that it is possible to derive the capillary force from the equation and the evaluations made on the contact angle of the liquid drop to a protective film 10. In Examples, water, which is representative of a water-based cleaning liquid, was used as the cleaning liquid. It had been confirmed from the above-mentioned equation that a contact angle closer to 90° makes the capillary force that acts on the recessed portions smaller; therefore, on the assumption that water is retained on the surface of the protective film, the contact angle is preferably from 50 to 130° because the pattern collapse becomes difficult to occur, and more preferably from 70 to 110°.

An evaluation of the contact angle of waterdrop is conducted by dropping several microliters of waterdrop on a surface of a sample (a substrate) and then by measuring an angle formed between the waterdrop and the substrate surface, as discussed in JIS R 3257 (Testing method of wettability of glass substrate surface). However, in the case of the wafer having a pattern, the contact angle is enormously large. This is because Wenzel's effect or Cassie's effect is caused so that an apparent contact angle of the waterdrop is increased under the influence of a surface shape (roughness) of the substrate upon the contact angle. Hence, in the case of a wafer having an unevenly patterned surface, it is not possible to exactly evaluate the contact angle of the protective film 10 itself, the protective film 10 being formed on the unevenly patterned surface.

In view of the above, in Examples of the present invention, the liquid chemical is supplied onto a wafer having a smooth surface to form a protective film on the surface of the wafer, the protective film being regarded as a protective film 10 formed on the surface of a wafer 1 having an uneven pattern 2 at its surface, thereby performing various evaluations. Incidentally, in Examples of the present invention, there were used as the wafer having a smooth surface: “a wafer with a tungsten film” (represented by “W” in Table) which has a tungsten layer on a silicon wafer having a smooth surface; “a wafer with a titanium nitride film” (represented by “TiN” in Table) which has a titanium nitride layer on a silicon wafer having a smooth surface; and “a wafer with a ruthenium film” (represented by “Ru” in Table) which has a ruthenium layer on a silicon wafer having a smooth surface.

Details will be discussed below. Hereinafter, there will be discussed: a method for evaluating the appearance of the liquid chemical for forming a protective film; a method for evaluating a wafer to which the liquid chemical for forming a protective film is supplied; preparation of the liquid chemical for forming a protective film; and results of evaluation after supplying the liquid chemical for forming a protective film to the wafer.

[Method for Evaluating Appearance of Liquid Chemical for Forming Protective Film]

The appearance of a prepared liquid chemical for forming a protective film was visually identified. An uniform, colorless and clear liquid was classified as acceptable one (indicated in Table 1 with A). A nonuniform liquid in which some undissolved matters were confirmed was classified as unacceptable one (indicated in Table 1 with B).

[Method for Evaluating Wafer to which Liquid Chemical for Forming Protective Film is Supplied]

As a method for evaluating a wafer to which a liquid chemical for forming a protective film has been supplied, the following evaluations (1) to (3) were performed.

(1) Evaluation of Contact Angle of Protective Film Formed on Wafer Surface

About 2 μl of pure water was dropped on a surface of a wafer on which a protective film was formed, followed by measuring an angle (contact angle) formed between the waterdrop and the wafer surface by using a contact angle meter (produced by Kyowa Interface Science Co., Ltd.: CA-X Model). A sample where a contact angle to the protective film was within a range of from 50 to 130° was classified as acceptable.

(2) Removability of Protective Film

A sample was irradiated with UV rays from a metal halide lamp for 2 hours under the following conditions, upon which the removability of the protective film, exhibited in the film-removing step was evaluated. A sample on which waterdrop had a contact angle of not larger than 30° after the irradiation was classified as acceptable one.
Lamp: M015-L312 produced by EYE GRAPHICS CO., LTD. (Intensity: 1.5 kW)
Illuminance: 128 mW/cm² as a measurement value obtained under the following conditions
Measuring Apparatus: Ultraviolet Intensity Meter (UM-10 produced by Konica Minolta Sensing, Inc.)
Light-Receptor: UM-360 (Light-Receptive Wavelength: 310-400 nm, Peak Wavelength: 365 nm)
Measuring Mode: Irradiance Measurement

(3) Evaluation of Surface Smoothness of Wafer after Removing Protective Film

The surface was observed by atomic force microscope (produced by Seiko Instruments Inc.: SPI3700, 2.5 micrometer square scan), and then there was obtained a difference ΔRa (nm) in the centerline average surface roughness Ra (nm) of the surface of the wafer between before and after the cleaning. Incidentally, “Ra” was a three-dimensionally enlarged one obtained by applying the centerline average roughness defined by JIS B 0601 to a measured surface and was calculated as “an average value of absolute values of difference from standard surface to designated surface” from the following equation.

$$R a = \frac{1}{{S}_{0}} {\int }_{{Y}_{T}}^{{Y}_{B}} {\int }_{{X}_{L}}^{{X}_{R}} \vert F ( X , Y ) - {Z}_{0} \vert d X d Y$$

wherein X_{L} and X_{R}, and Y_{R} and Y_{T} represent a measuring range in the X coordinate and the Y coordinate, respectively. S₀ represents an area obtained on the assumption that the measured surface is ideally flat, and is a value obtained by (X_{R}−X_{L})×(Y_{B}−Y_{T}). Additionally, F(X,Y) represents the height at a measured point (X,Y). Z₀ represents the average height within the measured surface.

The Ra value of the wafer surface before the protective film was formed thereon, and the Ra value of the wafer surface after the protective film was removed therefrom were measured. If a difference between them (ΔRa) was within ±1 nm, the wafer surface was regarded as not being eroded by the cleaning and regarded as not leaving residues of the protective film thereon, and therefore classified as an acceptable one (indicated in Table 1 with “A”).

### Example 1

(I-1) Preparation of Liquid Chemical for Forming Protective Film

A mixture of; 0.02 g of octylamine [C₈H₁₇NH₂] that has an HLB value of 2.5 and serves as a surfactant; and 99.98 g of pure water that serves as a solvent was prepared, followed by stirring for about 5 minutes, thereby obtaining an uniform, colorless and clear liquid chemical for forming a protective film, in which a concentration of the surfactant (hereinafter referred to as “a surfactant concentration”) was 0.02 mass % relative to the total amount of the liquid chemical for forming a protective film.

(I-2) Cleaning of Wafer with Titanium Nitride Film

A wafer having a smooth titanium nitride film (a silicon wafer on which surface a titanium nitride film of 50 nm thickness was formed) was immersed in 1 mass % aqueous hydrogen peroxide for 1 minute, then immersed in pure water for 1 minute, then immersed in isopropyl alcohol (iPA) for 1 minute, and then immersed in pure water for 1 minute.

(I-3) Surface Treatment of Surface of Wafer with Titanium Nitride Film, Using Liquid Chemical for Forming Protective Film

The wafer with a titanium nitride film was immersed in the liquid chemical for forming a protective film (the liquid chemical having been prepared as discussed in the above “(I-1) Preparation of Liquid Chemical for forming Protective Film” section) at 20° C. for 10 seconds. Subsequently, the wafer with a titanium nitride film was taken out thereof, followed by spraying air to remove the liquid chemical for forming a protective film from the surface.

As a result of evaluating the thus obtained wafer having a titanium nitride film in a manner discussed in the above [Method for Evaluating Wafer to which Liquid Chemical for Forming Protective Film is Supplied] section, a wafer having an initial contact angle of smaller than 10° before the surface treatment had come to have a contact angle of 80° after the surface treatment as shown in Table 1, with which it was confirmed that the water repellency-imparting effect was greatly exhibited. Moreover, the contact angle of the wafer after LTV irradiation was smaller than 10°, with which it was confirmed that removal of the water repellent protective film was achieved. Furthermore, a ΔRa value of the wafer after UV irradiation was within a range of ±0.5 nm, so that it was confirmed that the wafer was not eroded at the time of cleaning and that residues of the protective film did not remain after UV irradiation.

TABLE 1

| | | | | | | | | Cleaning before |
|---|---|---|---|---|---|---|---|---|
| | Liquid Chemical for Forming Protective Film | | | | | | | Surface Treatment |
| | | | Saturated | Surfactant | | | | with Liquid |
| | | | Concentration | Concentration | | | | Chemical for form- |
| | Surfactant | HLB | [mass %] | [mass %] | Solvent | Appearance | Wafer | ing Protective Film |
| Example 1 | C₈H₁₇NH₂ | 2.5 | 0.02 | 0.02 | Water | A | TiN | Water |
| Example 2 | C₆H₁₃NH₂ | 3.2 | 0.7 | 0.2 | Water | A | TiN | Water |
| Example 3 | C₁₀H₂₁NH₂ | 2 | 0.00005 | 0.00005 | Water | A | TiN | Water |
| Example 4 | C₈H₁₇NH₂ | 2.5 | 0.02 | 0.02 | Water | A | TiN | Water |
| Example 5 | C₈H₁₇NH₂ | 2.5 | 0.02 | 0.002 | Water | A | TiN | Water |
| Example 6 | C₈H₁₇NH₂ | 2.5 | 0.02 | 0.02 | Water | A | W | Water |
| Example 7 | C₆H₁₃NH₂ | 3.2 | 0.7 | 0.2 | Water | A | W | Water |
| Example 8 | C₁₀H₂₁NH₂ | 2 | 0.00005 | 0.00005 | Water | A | W | Water |
| Example 9 | C₈H₁₇NH₂ | 2.5 | 0.02 | 0.02 | Water | A | W | Water |
| Example 10 | C₈H₁₇NH₂ | 2.5 | 0.02 | 0.002 | Water | A | W | Water |
| Example 11 | C₈H₁₇NH₂ | 2.5 | 0.02 | 0.02 | Water | A | Ru | Water |
| Example 12 | C₆H₁₃NH₂ | 3.2 | 0.7 | 0.2 | Water | A | Ru | Water |
| Example 13 | C₁₀H₂₁NH₂ | 2 | 0.00005 | 0.00005 | Water | A | Ru | Water |
| Example 14 | C₈H₁₇NH₂ | 2.5 | 0.02 | 0.02 | Water | A | Ru | Water |
| Example 15 | C₈H₁₇NH₂ | 2.5 | 0.02 | 0.002 | Water | A | Ru | Water |
| Comparative | — | — | — | — | — | — | W | Water |
| Example 1 | | | | | | | | |
| Comparative | (CH₃)₃SiCl | — | — | 0.02 | Water | A | W | Water |
| Example 2 | | | | | | | | |
| Comparative | C₄H₉NH₂ | 4.4 | >0.7 | 0.7 | Water | A | W | Water |
| Example 3 | | | | | | | | |
| Comparative | — | — | — | — | — | — | TiN | Water |
| Example 4 | | | | | | | | |
| Comparative | (CH₃)₃SiCl | — | — | 0.02 | Water | A | TiN | Water |
| Example 5 | | | | | | | | |
| Comparative | C₄H₉NH₂ | 4.4 | >0.7 | 0.7 | Water | A | TiN | Water |
| Example 6 | | | | | | | | |
| Comparative | — | — | — | — | — | — | Ru | Water |
| Example 7 | | | | | | | | |
| Comparative | (CH₃)₃SiCl | — | — | 0.02 | Water | A | Ru | Water |
| Example 8 | | | | | | | | |
| Comparative | C₄H₉NH₂ | 4.4 | >0.7 | 0.7 | Water | A | Ru | Water |
| Example 9 | | | | | | | | |
| Comparative | ALSCOAP TH-330 | >10 | — | 0.02 | Water | A | TiN | Water |
| Example 10 | | | | | | | | |
| Comparative | C₈H₁₇NH₂ | 2.5 | 0.02 | 1 | Water | B | TiN | Water |
| Example 11 | | | | | | | | |

| | | | Evaluation Results | | | |
|---|---|---|---|---|---|---|
| | | | Initial | Contact Angle | Removability of | |
| | Immersion | | Contact | after Surface | Protective Film | Surface |
| | Temperature | Time | Angle | Treatment | (Contact Angle | Smoothness |
| | [° C.] | [sec] | [°] | ([°]) | [°]) | (ΔRa[nm]) |
| Example 1 | 20 | 10 | <10 | 80 | <10 | A |
| | | | | | | (Within ±0.5) |
| Example 2 | 20 | 10 | <10 | 63 | <10 | A |
| | | | | | | (Within ±0.5) |
| Example 3 | 20 | 10 | <10 | 93 | <10 | A |
| | | | | | | (Within ±0.5) |
| Example 4 | 20 | 30 | <10 | 78 | <10 | A |
| | | | | | | (Within ±0.5) |
| Example 5 | 20 | 10 | <10 | 80 | <10 | A |
| | | | | | | (Within ±0.5) |
| Example 6 | 20 | 10 | <10 | 83 | <10 | A |
| | | | | | | (Within ±0.5) |
| Example 7 | 20 | 10 | <10 | 65 | <10 | A |
| | | | | | | (Within ±0.5) |
| Example 8 | 20 | 10 | <10 | 95 | <10 | A |
| | | | | | | (Within ±0.5) |
| Example 9 | 20 | 30 | <10 | 78 | <10 | A |
| | | | | | | (Within ±0.5) |
| Example 10 | 20 | 10 | <10 | 77 | <10 | A |
| | | | | | | (Within ±0.5) |
| Example 11 | 20 | 10 | <10 | 86 | <10 | A |
| | | | | | | (Within ±0.5) |
| Example 12 | 20 | 10 | <10 | 68 | <10 | A |
| | | | | | | (Within ±0.5) |
| Example 13 | 20 | 10 | <10 | 90 | <10 | A |
| | | | | | | (Within ±0.5) |
| Example 14 | 20 | 30 | <10 | 86 | <10 | A |
| | | | | | | (Within ±0.5) |
| Example 15 | 20 | 10 | <10 | 82 | <10 | A |
| | | | | | | (Within ±0.5) |
| Comparative | — | — | <10 | 14 | — | — |
| Example 1 | | | | | | |
| Comparative | 20 | 10 | <10 | 13 | — | — |
| Example 2 | | | | | | |
| Comparative | 20 | 10 | <10 | 42 | — | — |
| Example 3 | | | | | | |
| Comparative | — | — | <10 | 14 | — | — |
| Example 4 | | | | | | |
| Comparative | 20 | 10 | <10 | 18 | — | — |
| Example 5 | | | | | | |
| Comparative | 20 | 10 | <10 | 38 | — | — |
| Example 6 | | | | | | |
| Comparative | — | — | <10 | 14 | — | — |
| Example 7 | | | | | | |
| Comparative | 20 | 10 | <10 | 16 | — | — |
| Example 8 | | | | | | |
| Comparative | 20 | 10 | <10 | 36 | — | — |
| Example 9 | | | | | | |
| Comparative | 20 | 10 | <10 | 13 | — | — |
| Example 10 | | | | | | |
| Comparative | 20 | 10 | <10 | 81 | <10 | A |
| Example 11 | | | | | | (Within ±0.5) |

### Examples 2 to 5

Upon modifying Example 1 with regard to the surfactant, the surfactant concentration and the time for immersion in the liquid chemical for forming a protective film, there was conducted a surface treatment of wafers, followed by evaluation of these. Results are shown in Table 1.

### Example 6

(II-1) Preparation of Liquid Chemical for Forming Protective Film

A mixture of; 0.02 g of octylamine [C₈H₁₇NH₂] that has an HLB value of 2.5 and serves as a surfactant; and 99.98 g of pure water that serves as a solvent was prepared, followed by stirring for about 5 minutes, thereby obtaining a liquid chemical for forming a protective film having a surfactant concentration of 0.02 mass %.

(II-2) Cleaning of Wafer with Tungsten Film

A wafer having a smooth tungsten film (a silicon wafer on which surface a tungsten film of 50 nm thickness was formed) was immersed in 1 mass % aqueous ammonia for 1 minute, then immersed in pure water for 1 minute, then immersed in iPA for 1 minute, and then immersed in pure water for 1 minute.

(II-3) Surface Treatment of Surface of Wafer with Tungsten Film, Using Liquid Chemical for Forming Protective Film

The wafer with a tungsten film was immersed in the liquid chemical for forming a protective film (the liquid chemical having been prepared as discussed in the above “(II-1) Preparation of Liquid Chemical for forming Protective Film” section) at 20° C. for 10 seconds. Subsequently, the wafer with a tungsten film was taken out thereof, followed by spraying air to remove the liquid chemical for forming a protective film from the surface.

As a result of evaluating the thus obtained wafer having a tungsten film in a manner discussed in the above [Method for Evaluating Wafer to which Liquid Chemical for Forming Protective Film is Supplied] section, a wafer having an initial contact angle of smaller than 10° before the surface treatment had come to have a contact angle of 83° after the surface treatment as shown in Table 1, with which it was confirmed that the water repellency-imparting effect was greatly exhibited. Moreover, the contact angle of the wafer after LTV irradiation was smaller than 10°, with which it was confirmed that removal of the water repellent protective film was achieved. Furthermore, a ΔRa value of the wafer after UV irradiation was within a range of ±0.5 nm, so that it was confirmed that the wafer was not eroded at the time of cleaning and that residues of the protective film did not remain after UV irradiation.

### Examples 7 to 10

Upon modifying Example 7 with regard to the surfactant, the surfactant concentration and the time for immersion in the liquid chemical for forming a protective film, there was conducted a surface treatment of wafers, followed by evaluation of these. Results are shown in Table 1.

### Example 11

(III-1) Preparation of Liquid Chemical for Forming Protective Film

A mixture of; 0.02 g of octylamine [C₈H₁₇NH₂] that has an HLB value of 2.5 and serves as a surfactant; and 99.98 g of pure water that serves as a solvent was prepared, followed by stirring for about 5 minutes, thereby obtaining a liquid chemical for forming a protective film having a surfactant concentration of 0.02 mass %.

(III-2) Cleaning of Wafer with Ruthenium Film

A wafer having a smooth ruthenium film (a silicon wafer on which surface a ruthenium film of 300 nm thickness was formed) was immersed in 1 mass % aqueous ammonia for 1 minute, then immersed in pure water for 1 minute, then immersed in iPA for 1 minute, and then immersed in pure water for 1 minute.

(III-3) Surface Treatment of Surface of Wafer with Ruthenium Film, Using Liquid Chemical for Forming Protective Film

The wafer with a ruthenium film was immersed in the liquid chemical for forming a protective film (the liquid chemical having been prepared as discussed in the above “(III-1) Preparation of Liquid Chemical for forming Protective Film” section) at 20° C. for 10 seconds. Subsequently, the wafer with a ruthenium film was taken out thereof, followed by spraying air to remove the liquid chemical for forming a protective film from the surface.

As a result of evaluating the thus obtained wafer having a ruthenium film in a manner discussed in the above [Method for Evaluating Wafer to which Liquid Chemical for Forming Protective Film is Supplied] section, a wafer having an initial contact angle of smaller than 10° before the surface treatment had come to have a contact angle of 86° after the surface treatment as shown in Table 1, with which it was confirmed that the water repellency-imparting effect was greatly exhibited. Moreover, the contact angle of the wafer after UV irradiation was smaller than 10°, with which it was confirmed that removal of the water repellent protective film was achieved. Furthermore, a ΔRa value of the wafer after UV irradiation was within a range of ±0.5 nm, so that it was confirmed that the wafer was not eroded at the time of cleaning and that residues of the protective film did not remain after UV irradiation.

### Examples 12 to 15

Upon modifying Example 11 with regard to the surfactant, the surfactant concentration and the time for immersion in the liquid chemical for forming a protective film, there was conducted a surface treatment of wafers, followed by evaluation of these. Results are shown in Table 1.

### Comparative Example 1

The procedure of Example 6 was repeated with the exception that the liquid chemical for forming a protective film was not supplied to the wafer with a tungsten film. In the present comparative example, in other words, a wafer surface on which the water repellent protective film was not formed was subjected to evaluation. Results of the evaluation are as shown in Table 1. The contact angle on the wafer was 14° and therefore the water repellency-imparting effect was not confirmed.

### Comparative Example 2

First of all, 0.02 g of trimethylsilyl chloride [(CH₃)₃SiCl] that serves as a silane coupling agent, and 99.98 g of water as a solvent were mixed. The mixture solution was stirred for about 5 minutes, thereby obtaining a liquid chemical for forming a protective film, in which a concentration of the silane coupling agent was 0.02 mass % relative to the total amount of the mixture solution. Subsequently, there were performed a cleaning and a surface treatment of the wafer with a tungsten film, according to the same method as that of Example 6. Results of the evaluation are as shown in Table 1. The contact angle after the surface treatment was 13° and therefore the water repellency-imparting effect was not confirmed.

### Comparative Example 3

There were performed a cleaning and a surface treatment of a wafer with a tungsten film, according to the same method as that of Example 6 with the exception that butylamine [C₄H₉NH₂] (HLB value: 4.4) including a hydrophobic moiety having a C₄ hydrocarbon group was used as the surfactant. Results of the evaluation are as shown in Table 1. The contact angle after the surface treatment was 42° and therefore the water repellency-imparting effect was not confirmed.

### Comparative Example 4

The procedure of Example 1 was repeated with the exception that the liquid chemical for forming a protective film was not supplied to the wafer with a titanium nitride film. In the present comparative example, in other words, a wafer surface on which the water repellent protective film was not formed was subjected to evaluation. Results of the evaluation are as shown in Table 1. The contact angle on the wafer was 14° and therefore the water repellency-imparting effect was not confirmed.

### Comparative Example 5

First of all, 0.02 g of trimethylsilyl chloride [(CH₃)₃SiCl] that serves as a silane coupling agent, and 99.98 g of water as a solvent were mixed. The mixture solution was stirred for about 5 minutes, thereby obtaining a liquid chemical for forming a protective film, in which a concentration of the silane coupling agent was 0.02 mass % relative to the total amount of the mixture solution. Subsequently, there were performed a cleaning and a surface treatment of the wafer with a titanium nitride film, according to the same method as that of Example 1. Results of the evaluation are as shown in Table 1. The contact angle after the surface treatment was 18° and therefore the water repellency-imparting effect was not confirmed.

### Comparative Example 6

There were performed a cleaning and a surface treatment of a wafer with a titanium nitride film, according to the same method as that of Example 1 with the exception that butylamine [C₄H₉NH₂] (HLB value: 4.4) including a hydrophobic moiety having a C₄ hydrocarbon group was used as the surfactant. Results of the evaluation are as shown in Table 1. The contact angle after the surface treatment was 38° and therefore the water repellency-imparting effect was not confirmed.

### Comparative Example 7

The procedure of Example 11 was repeated with the exception that the liquid chemical for forming a protective film was not supplied to the wafer with a ruthenium film. In the present comparative example, in other words, a wafer surface on which the water repellent protective film was not formed was subjected to evaluation. Results of the evaluation are as shown in Table 1. The contact angle on the wafer was 14° and therefore the water repellency-imparting effect was not confirmed.

### Comparative Example 8

First of all, 0.02 g of trimethylsilyl chloride [(CH₃)₃SiCl] that serves as a silane coupling agent, and 99.98 g of water as a solvent were mixed. The mixture solution was stirred for about 5 minutes, thereby obtaining a liquid chemical for forming a protective film, in which a concentration of the silane coupling agent was 0.02 mass % relative to the total amount of the mixture solution. Subsequently, there were performed a cleaning and a surface treatment of the wafer with a ruthenium film, according to the same method as that of Example 11. Results of the evaluation are as shown in Table 1. The contact angle after the surface treatment was 16° and therefore the water repellency-imparting effect was not confirmed.

### Comparative Example 9

There were performed a cleaning and a surface treatment of a wafer with a ruthenium film, according to the same method as that of Example 11 with the exception that butylamine [C₄H₉NH₂] (HLB value: 4.4) including a hydrophobic moiety having a C₄ hydrocarbon group was used as the surfactant. Results of the evaluation are as shown in Table 1. The contact angle after the surface treatment was 36° and therefore the water repellency-imparting effect was not confirmed.

### Comparative Example 10

The procedure of Example 1 was repeated with the exception that sodium polyoxyethylene lauryl ether sulfate having an estimated HLB value of more than 10 (“ALSCOAP TH-330” produced by TOHO Chemical Industry Co., Ltd.) was used as the surfactant in the liquid chemical for forming a protective film. Results of the evaluation are as shown in Table 1. The contact angle after the surface treatment was 13° and therefore the water repellency-imparting effect was not confirmed.

### Comparative Example 11

The procedure of Example 1 was repeated with the exception that the surfactant concentration (a mixture amount) in the liquid chemical for forming a protective film exceeds the saturated concentration, i.e., 1.0 mass %. As a result of identifying the appearance of the prepared liquid chemical for forming a protective film, it was confirmed that a nonuniform whitish liquid was obtained and a good liquid chemical for forming a protective film was not obtained.

### EXPLANATION OF REFERENCE NUMERALS

1 Wafer
2 Uneven pattern on a wafer surface
3 Projected portions of the pattern
4 Recessed portions of the pattern
5 Width of the recessed portions
6 Height of the projected portions
7 Width of the projected portions
8 Liquid chemical for forming a protective film, retained in the recessed portions 4
9 Liquid retained in the recessed portions 4
10 Water repellent protective film

1. A liquid chemical for forming a water repellent protective film, the liquid chemical being able to form a water repellent protective film on a wafer that has at its surface an uneven pattern and contains at least one kind of element selected from the group consisting of titanium, tungsten, aluminum, copper, tin, tantalum and ruthenium at surfaces of recessed portions of the uneven pattern, the protective film being formed at least on the surfaces of the recessed portions, the liquid chemical comprising:
a surfactant which has an HLB value of 0.001-10 according to Griffin's method and includes a hydrophobic moiety having a C₆-C₁₈ hydrocarbon group; and
water,
wherein the concentration of the surfactant in the liquid chemical is not smaller than 0.00001 mass % relative to 100 mass % of the total amount of the liquid chemical and not larger than the saturated concentration.

2. A liquid chemical for forming a water repellent protective film, as claimed in claim 1, wherein the surfactant includes a hydrophobic moiety having a C₈-C₁₈ hydrocarbon group.

3. A liquid chemical for forming a water repellent protective film, as claimed in claim 1, wherein the surfactant contains a functional moiety that has an affinity with the element.

4. A liquid chemical for forming a water repellent protective film, as claimed in claim 1, wherein the surfactant contains, in its structure, one functional moiety that has an affinity with the element.

5. A liquid chemical for forming a water repellent protective film, as claimed in claim 1, wherein the surfactant includes a hydrophobic moiety having a C₆-C₁₈ straight-chain hydrocarbon group.

6. A liquid chemical for forming a water repellent protective film, as claimed in claim 1, wherein the surfactant includes a hydrophobic moiety having a C₆-C₁₈ straight-chain hydrocarbon group that consists of carbon element and hydrogen element.

7. A liquid chemical for forming a water repellent protective film, as claimed in claim 1, wherein a solvent is further contained in the liquid chemical and the concentration of water relative to the total amount of the solvent is not lower than 50 mass %.

8. A liquid chemical for forming a water repellent protective film, as claimed in claim 1, wherein the liquid chemical consists of the surfactant and water.

9. A method for cleaning a surface of a wafer that has at its surface an uneven pattern and contains at least one kind of element selected from the group consisting of titanium, tungsten, aluminum, copper, tin, tantalum and ruthenium at surfaces of recessed portions of the uneven pattern, the method using a liquid chemical for forming a water repellent protective film as claimed in claim 1, the method by comprising:
a step of cleaning a surface of a wafer by using a cleaning liquid;
a step of forming a water repellent protective film at least on surfaces of recessed portions of the uneven pattern by using the liquid chemical for forming a water repellent protective film;
a step of removing a liquid formed of the cleaning liquid and/or the liquid chemical, retained on the surfaces of the uneven pattern, from the surfaces of the uneven pattern; and
a step of removing the water repellent protective film after the step of removing the liquid.

10. A method for cleaning a surface of a wafer, as claimed in claim 9, wherein the cleaning liquid is a water-based cleaning liquid.
